(19) United States
(12) Patent Application Publication
(10) Pub. No.: US 2018/0307294 A1
(43) Pub. Date: Oct. 25, 2018

(54) ELECTRONIC DEVICE, CONTROL CIRCUIT, AND METHOD OF CONTROLLING ELECTRONIC DEVICE

(71) Applicant: Sony Semiconductor Solutions Corporation, Kanagawa (JP)

(72) Inventors: Nobuo Kato, Kanagawa (JP); Katsumi Takaoka, Tokyo (JP); Hideki Takahashi, Kanagawa (JP); Yoshitaka Suga, Kanagawa (JP); Kosei Yamashita, Kanagawa (JP); Yuken Goto, Tokyo (JP); Hiroyuki Okumura, Kanagawa (JP)

(21) Appl. No.: 15/765,911

(22) PCT Filed: Sep. 21, 2016
(86) PCT No.: PCT/JP2016/077796

§ 371 Date: Apr. 4, 2018

(30) Foreign Application Priority Data
Nov. 10, 2015 (JP) 2015-220071

(51) Int. Cl. G06F 1/32; G06F 3/0346

(52) U.S. Cl. CPC G06F 1/3231; G06F 1/3287; G06F 3/0346

(57) ABSTRACT

Power consumption by an electronic device carried by a user is to be reduced.

The electronic device includes a detection unit, a simplified analysis unit, and a detailed analysis unit. The detection unit detects the presence/absence of movement of the electronic device. A power control unit starts a supply of electric power when there is movement in the electronic device. The simplified analysis unit performs a simplified analysis process while consuming the electric power, the simplified analysis process being a process of analyzing the data obtained from the electronic device. In accordance with an analysis result of the simplified analysis process, the detailed analysis unit performs a detailed analysis process while consuming the electric power, the detailed analysis process being a different process from the simplified analysis process.

### TECHNICAL FIELD

The present technology relates to an electronic device, a control circuit, and a method of controlling the electronic device. More particularly, the present technology relates to an electronic device to be carried by a user, a control circuit, and a control method of the electronic device.

### BACKGROUND ART

In a conventional small electronic device such as a smartphone or a smartwatch, the battery capacity is limited due to physical restrictions. Therefore, there is a demand for devices that consume less electric power. For example, there is an electronic device that detects the presence/absence of movement of an electronic device in accordance with the value of an acceleration rate or the like, switches to a power saving mode in a case where there is no movement, and returns from the power saving mode in a case where there is movement (see Patent Document 1, for example). A small-sized electronic device is often used by a user while he/she is walking and carrying the device. Therefore, in a case where an electronic device is not carried by the user and does not move, the electronic device switches to the power saving mode, so that power consumption can be reduced. When the electronic device moves as the electronic device is used while the user is walking, for example, the electronic device returns from the power saving mode.

### CITATION LIST

### Patent Document

### Patent Document 1: JP 2012-519989 W

### SUMMARY OF THE INVENTION

### Problems to be Solved by the Invention

According to the above mentioned conventional technology, movement of an electronic device might be detected, and the electronic device might return from a power saving mode, even though the user is not carrying the electronic device, in a case where the user has just dropped the electronic device, for example. As a result, the electronic device might unnecessarily consume electric power.

The present technology has been developed in view of such circumstances, and aims to reduce power consumption by an electronic device carried by a user.

### Solutions to Problems

The present technology has been developed to solve the above described problems, and a first aspect thereof is an electronic device that includes: a detection unit that detects the presence/absence of movement in the electronic device; a power control unit that starts a supply of electric power in a case where there is movement in the electronic device; a simplified analysis unit that performs a simplified analysis process while consuming the electric power, the simplified analysis process being a process of analyzing data obtained from the electronic device; and a detailed analysis unit that performs a detailed analysis process in accordance with an analysis result of the simplified analysis process while consuming the electric power, the detailed analysis process being a different process from the simplified analysis process. The first aspect of the present technology is also a method of controlling the electronic device. With this configuration, a detailed analysis process is effectively performed in accordance with an analysis result of a simplified analysis process.

Further, in the first aspect, the simplified analysis unit may analyze the data in the simplified analysis process and determine whether a user of the electronic device is walking, and, if the user is determined to be walking, the detailed analysis unit may perform the detailed analysis process. With this, the detailed analysis process is effectively performed in a case where the user is walking.

Also in the first aspect, the detection unit may include: a sensor that generates the data; and a sensor data acquisition unit that acquires the data, and detects the presence/absence of movement in the electronic device in accordance with the data. With this configuration, the presence/absence of movement of the electronic device is effectively detected in accordance with the data from the sensor.

Further, in the first aspect, the sensor data acquisition unit may perform a decimation process of discarding the corresponding number of sets of the data at a predetermined decimation rate every time acquiring a predetermined number of sets of the data, and a detection process of detecting the presence/absence of movement of the electronic device in accordance with the data that has not been discarded. With this configuration, every time a predetermined number of sets of the data are acquired, the corresponding number of sets of the data are discarded at a predetermined decimation rate.

Further, in the first aspect, the sensor data acquisition unit may include: a sensor data read unit that reads the data from the sensor; a filtering unit that performs a predetermined filtering process on the data; a normalization unit that performs a predetermined normalization process on the data; a threshold determination unit that compares the data with a predetermined threshold value, and determines the presence/absence of movement of the electronic device; and a connection control unit that controls the connection relation among the sensor data read unit, the filtering unit, the normalization unit, and the threshold determination unit. With this configuration, the connection relation among the sensor data read unit, the filtering unit, the normalization unit, and the threshold determination unit is effectively controlled.

Also in the first aspect, the sensor may include: a light-emitting diode; a photodetector that detects the presence/absence of light, and generates an analog detection signal; and an analog-to-digital converter that converts the detection signal into the data. The sensor data acquisition unit may synchronize the light emission timing of the light-emitting diode with the timing at which the analog-to-digital converter converts the detection signal. With this configuration, the light-emitting diode emits light in synchronization with the timing at which the analog-to-digital converter converts the detection signal.

Further, in the first aspect, the sensor data acquisition unit may include a holding unit that holds a constant number of sets of the data in order of acquisition of the data, and the simplified analysis unit may perform the simplified analysis process by reading the data from the holding unit in the order of acquisition of the data. With this configuration, the data is read from the holding unit in the order of acquisition.

Also in the first aspect, the holding unit may hold the data and the time at which the data was acquired, the data and the time being associated with each other. With this arrangement, the time at which the data was acquired, and the data associated with the time are effectively read out.

Further, in the first aspect, the electronic device may further include a holding unit that holds a constant number of sets of the data in order of acquisition of the data, using the electric power, and the simplified analysis unit may perform the simplified analysis process by reading the data from the holding unit in the order of acquisition of the data. With this arrangement, the data is effectively held in a case where there is movement in the electronic device.

Also in the first aspect, the detection unit may include: a sensor that generates the data, and senses the presence/absence of movement of the electronic device in accordance with the data; and a data acquisition unit that acquires the data. With this arrangement, the presence/absence of movement of the electronic device is detected by the sensor.

Meanwhile, a second aspect of the present technology is a control circuit that includes: a power control unit that starts a supply of electric power in a case where there is movement in an electronic device; a simplified analysis unit that performs a simplified analysis process while consuming the electric power, the simplified analysis process being a process of analyzing data obtained from the electronic device; and a detailed analysis unit that performs a detailed analysis process in accordance with an analysis result of the simplified analysis process while consuming the electric power, the detailed analysis process being a different process from the simplified analysis process. With this configuration, a detailed analysis process is effectively performed in accordance with an analysis result of a simplified analysis process.

### Effects of the Invention

According to the present technology, it is possible to achieve a great effect to reduce power consumption by an electronic device carried by a user. It should be noted that the effects of the present technology are not necessarily limited to the effects described herein, and may include any of the effects described in the present disclosure.

### BRIEF DESCRIPTION OF DRAWINGS

FIG. 1 is a block diagram showing an example configuration of an electronic device according to a first embodiment.

FIG. 2 is a block diagram showing an example configuration of a power control unit according to the first embodiment.

FIG. 3 is a block diagram showing an example configuration of a sensor data acquisition unit according to the first embodiment.

FIG. 4 is a diagram showing an example configuration of a FIFO memory according to the first embodiment.

FIG. 5 is a block diagram showing an example configuration of an arithmetic processing unit according to the first embodiment.

FIG. 6 is a block diagram showing an example configuration of a preprocessing unit according to the first embodiment.

FIG. 7 is a block diagram showing an example configuration of a decimation unit according to the first embodiment.

FIG. 8 is a block diagram showing an example configuration of a common processing unit according to the first embodiment.

FIG. 9 is a block diagram showing an example configuration of a decimator according to the first embodiment.

FIG. 10 is a block diagram showing an example configuration of a function execution unit according to the first embodiment.

FIG. 11 is a block diagram showing an example configuration of a function execution circuit according to the first embodiment.

FIG. 12 is a block diagram showing an example configuration of an infinite impulse response (IIR) filter according to the first embodiment.

FIG. 13 is a block diagram showing an example configuration of a normalization unit according to the first embodiment.

FIG. 14 is a block diagram showing an example configuration of a threshold determination unit according to the first embodiment.

FIG. 15 is a graph showing an example of fluctuations of an acceleration rate, count values, and a trigger signal in the first embodiment.

FIG. 16 is a diagram showing an example setting of a topology pattern b0001 according to the first embodiment.

FIG. 17 is a diagram showing an example setting of a topology pattern b0010 according to the first embodiment.

FIG. 18 is a diagram showing an example setting of a topology pattern b0100 according to the first embodiment.

FIG. 19 is a diagram showing an example setting of a topology pattern b1000 according to the first embodiment.

FIG. 20 is a diagram showing an example setting of a topology pattern b0011 according to the first embodiment.

FIG. 21 is a diagram showing an example setting of a topology pattern b0110 according to the first embodiment.

FIG. 22 is a diagram showing an example setting of a topology pattern b1100 according to the first embodiment.

FIG. 23 is a diagram showing an example setting of a topology pattern b1001 according to the first embodiment.

FIG. 24 is a diagram showing an example setting of a topology pattern b0101 according to the first embodiment.

FIG. 25 is a diagram showing an example setting of a topology pattern b1010 according to the first embodiment.

FIG. 26 is a diagram showing an example setting of a topology pattern b1101 according to the first embodiment.

FIG. 27 is a diagram showing an example of data paths according to the first embodiment.

FIG. 28 is a flowchart showing an example operation of the electronic device according to the first embodiment.

FIG. 29 is a diagram showing an example state of a control circuit prior to movement detection according to the first embodiment.

FIG. 30 is a diagram showing an example state of the control circuit at a time of simplified analysis after movement detection according to the first embodiment.

FIG. 31 is a diagram showing an example state of the control circuit at a time of detailed analysis according to the first embodiment.

FIG. 32 is a block diagram showing an example configuration of an electronic device according to a second embodiment.

FIG. 33 is a block diagram showing an example configuration of a function execution unit according to the second embodiment.

FIG. 34 is a block diagram showing an example configuration of a sensor data acquisition unit according to a third embodiment.

FIG. 35 is a block diagram showing an example configuration of a data processing unit according to the third embodiment.

FIG. 36 is a block diagram showing an example configuration of an electronic device according to a modification.

FIG. 37 is a block diagram showing an example configuration of a pulse wave sensor according to the modification.

### MODE FOR CARRYING OUT THE INVENTION

The following is a description of modes for carrying out the present technology (the modes will be hereinafter referred to as the embodiments). Explanation will be made in the following order.

1. First embodiment (an example in which detailed analysis is conducted when the user is walking)

2. Second embodiment (an example in which detailed analysis is conducted when a sensor senses movement and the user is walking)

3. Third embodiment (an example in which a memory is provided in a detailed analysis module, and detailed analysis is conducted when the user is walking)

4. Modification

### 1. First Embodiment

[Example Configuration of an Electronic Device]

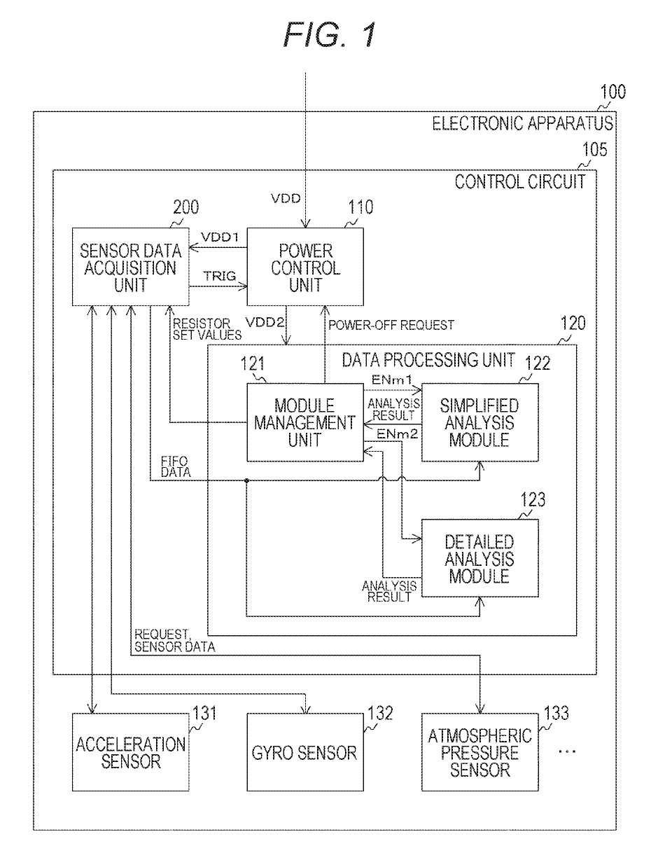

FIG. 1 is a block diagram showing an example configuration of an electronic device 100 according to a first embodiment. The electronic device 100 includes a plurality of sensors such as an acceleration sensor 131, a gyro sensor 132, and an atmospheric pressure sensor 133, and a control circuit 105. A mobile device such as a smartphone or a smartwatch may be the electronic device 100.

The control circuit 105 controls the entire electronic device 100. The control circuit 105 includes a sensor data acquisition unit 200, a power control unit 110, and a data processing unit 120. Further, the data processing unit 120 includes a module management unit 121, a simplified analysis module 122, and a detailed analysis module 123. The control circuit 105 is incorporated into an application processor that controls a large number of peripheral devices, for example.

The sensor data acquisition unit 200 acquires sensor data that is data from various kinds of sensors such as the acceleration sensor 131. The sensor data acquisition unit 200 holds the sensor data in chronological order by a first-in first-out (FIFO) method, and, in accordance with the sensor data, detects presence/absence of movement of the electronic device 100. For example, the sensor data acquisition unit 200 compares the value of sensor data indicating an acceleration rate with a predetermined threshold value, and, from a result of the comparison, senses that the electronic device 100 has moved. Then, if there is movement, the sensor data acquisition unit 200 generates a trigger signal TRIG, and supplies the trigger signal TRIG to the power control unit 110. Further, the sensor data acquisition unit 200 supplies the held sensor data as FIFO data to the data processing unit 120.

The power control unit 110 controls the power to be supplied to the sensor data acquisition unit 200 and the data processing unit 120. In accordance with power VDD from outside the electronic device 100, the power control unit 110 applies power VDD1 to the sensor data acquisition unit 200, and applies power VDD2 to the data processing unit 120. Further, upon receipt of a power-off request for power supply shut-off from the data processing unit 120, the power VDD2 to the data processing unit 120 is shut off.

Here, a state where the power VDD2 to the data processing unit 120 is off, and power is being applied only to the sensor data acquisition unit 200 and the power control unit 110 will be hereinafter referred to as the “sleep mode”. On the other hand, a state where power is being applied to all of the sensor data acquisition unit 200, the power control unit 110, and the data processing unit 120 will be hereinafter referred to as the “normal mode”.

Further, upon receipt of the trigger signal TRIG from the sensor data acquisition unit 200 after shut-off of the power to the data processing unit 120 (or after transition to the sleep mode), a power management unit 112 re-applies the power VDD2 to the data processing unit 120.

It should be noted that the power control unit 110 may supply power to the sensor data acquisition unit 200 and the data processing unit 120, using power from a battery provided inside the electronic device 100, instead of power from outside the electronic device 100.

The module management unit 121 manages the simplified analysis module 122 and the detailed analysis module 123. The module management unit 121 sets register set values for controlling the sensor data acquisition unit 200 in accordance with a user operation or an application, and supplies the register set values to the sensor data acquisition unit 200.

The module management unit 121 also determines whether to switch to the sleep mode from the normal mode. For example, in a case where an instruction to switch to the sleep mode is issued by a user or an application, where any user operation has not been performed over a certain period of time, or where processing by the detailed analysis module 123 is completed, the electronic device 100 switches to the sleep mode.

When the electronic device 100 switches to the sleep mode, the module management unit 121 stops the simplified analysis module 122 with an enable signal ENm1, and stops the detailed analysis module 123 with an enable signal ENm2. These enable signals are signals for controlling whether to operate the simplified analysis module 122 or the detailed analysis module 123. Then, after stopping these modules, the module management unit 121 supplies a power-off request to the power control unit 110.

Further, when the power VDD2 is supplied to cause the electronic device 100 to return from the sleep mode, the module management unit 121 first activates the simplified analysis module 122 with the enable signal ENm1.

The simplified analysis module 122 performs a simplified analysis process that is a process of analyzing sensor data obtained from the electronic device 100, using the power VDD2. For example, in accordance with a history of FIFO data indicating acceleration rates, a check is made to determine whether the user is walking. The simplified analysis module 122 supplies an analysis result to the module management unit 121. It should be noted that the simplified analysis module 122 is an example of the simplified analysis unit described in the claims.

Then, upon receipt of an analysis result indicating that the user is walking, the module management unit 121 activates the detailed analysis module 123 with the enable signal ENm2. Upon receipt of an analysis result indicating that the user is not walking, on the other hand, the module management unit 121 stops the simplified analysis module 122, and supplies a power-off request to the power control unit 110.

The detailed analysis module 123 performs a detailed analysis process that differs from the simplified analysis process and is a process of analyzing sensor data using the power VDD2. The throughput per unit time in this detailed analysis process is higher than that in the simplified analysis process. The detailed analysis process may be a process of counting the number of steps, or a process of generating a walking route of the user, for example. The detailed analysis module 123 supplies an analysis result to the module management unit 121. It should be noted that the detailed analysis module 123 is an example of the detailed analysis unit described in the claims.

The acceleration sensor 131 measures the acceleration rate of the electronic device 100, and outputs sensor data indicating the measured value to the control circuit 105. The gyro sensor 132 measures the angular velocity and the angular acceleration rate of the electronic device 100, and outputs sensor data indicating the measured values to the control circuit 105. The atmospheric pressure sensor 133 measures atmospheric pressure, and outputs sensor data indicating the measured value to the control circuit 105. It should be noted that the acceleration sensor 131, the gyro sensor 132, and the atmospheric pressure sensor 133 are examples of the sensor described in the claims.

Note that although the electronic device 100 includes the acceleration sensor 131, the gyro sensor 132, and the atmospheric pressure sensor 133, there is no need to include all of these sensors. For example, the gyro sensor 132 and the atmospheric pressure sensor 133 may not be included. Alternatively, other than the acceleration sensor 131, the gyro sensor 132, and the atmospheric pressure sensor 133, a sensor such as a global positioning system (GPS) sensor may be further included.

[Example Configuration of the Power Control Unit]

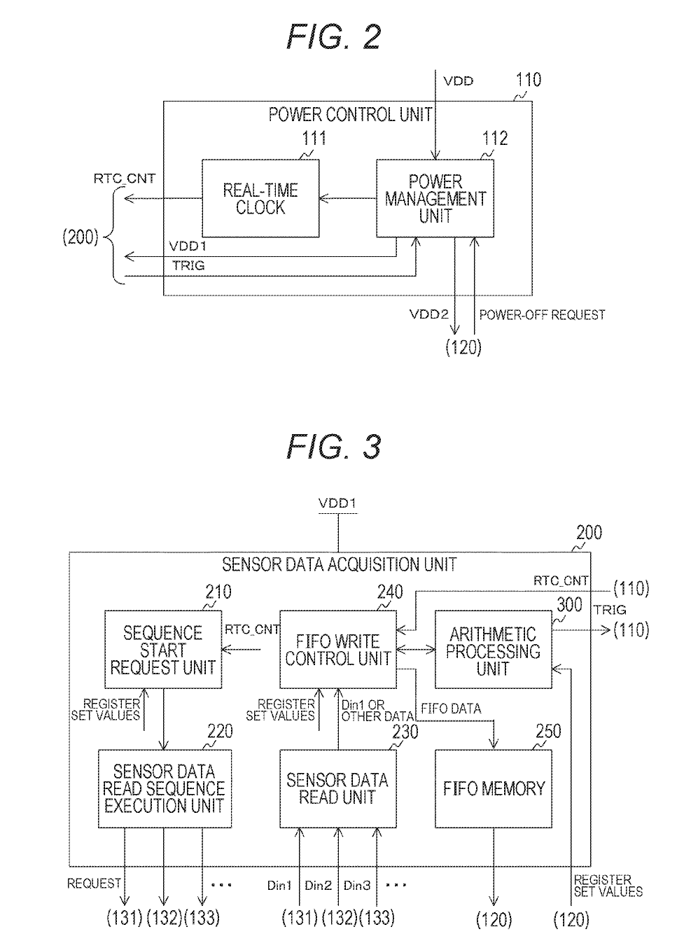

FIG. 2 is a block diagram showing an example configuration of the power control unit 110 according to the first embodiment. The power control unit 110 includes a real-time clock 111 and a power management unit 112.

The real-time clock 111 measures the current time. The real-time clock 111 includes a battery and a timing circuit, for example, and continues to perform timing with the power of the battery even if the power to the power management unit 112 is shut off. The real-time clock 111 measures the count value in synchronization with a clock signal at 32.768 kilohertz (kHz), for example, and supplies the count value as the current time RTC_CNT to the sensor data acquisition unit 200. It should be noted that the time resolution is not necessarily 32.768 kilohertz (kHz). Furthermore, although the real-time clock 111 is provided in the power control unit 110, the present invention is not limited to this configuration. For example, the sensor data acquisition unit 200 may include the real-time clock 111.

The power management unit 112 manages the power to the entire electronic device 100. In accordance with the power VDD from outside the electronic device 100, the power management unit 112 applies the power VDD1 to the sensor data acquisition unit 200, and applies the power VDD2 to the data processing unit 120. Also, upon receipt of a power-off request from the data processing unit 120, the power VDD2 to the data processing unit 120 is shut off. Then, upon receipt of the trigger signal TRIG from the sensor data acquisition unit 200 after the power to the data processing unit 120 is shut off, the power management unit 112 re-applies the power VDD2 to the data processing unit 120.

[Example Configuration of the Sensor Data Acquisition Unit]

FIG. 3 is a block diagram showing an example configuration of the sensor data acquisition unit 200 according to the first embodiment. The sensor data acquisition unit 200 includes a sequence start request unit 210, a sensor data read sequence execution unit 220, and a sensor data read unit 230. The sensor data acquisition unit 200 also includes a FIFO write control unit 240, a FIFO memory 250, and an arithmetic processing unit 300.

The sequence start request unit 210 requests the sensor data read sequence execution unit 220 to start a sequence for reading sensor data, in accordance with the register set values. Here, the sequence shows a procedure for executing a certain number of transactions for each sensor, each transaction being a series of processes for reading sensor data over a certain period of time. Each of the settings necessary for executing this sequence is performed by the data processing unit 120. For example, the intervals at which the transactions are executed, the sampling rate, the time period during which each transaction is executed, the data size of the sensor data, and the like are set as the register set values for each sensor.

The start time of the sequence is also set in the register set values, and the sequence start request unit 210 requests the start of the sequence when the current time RTC_CNT reaches the start time.

The sensor data read sequence execution unit 220 executes the sequence when the start of the sequence is requested. Each time the sampling period corresponding to a sensor (such as the acceleration sensor 131) elapses, the sensor data read sequence execution unit 220 issues a request as a sensor data output instruction, and supplies the request to the sensor.

The sensor data read unit 230 reads sensor data. For each sensor, the sensor data read unit 230 acquires sensor data that is output in response to a request. For example, sensor data Din1 is acquired from the acceleration sensor 131, and sensor data Din2 and Din3 are acquired from the gyro sensor 132 and the atmospheric pressure sensor 133. The sensor data read unit 230 supplies the sensor data to the FIFO write control unit 240.

The sensor data and requests are transmitted/received via a serial peripheral interface (SPI) or an interface of an inter integrated circuit (I2C), for example. It should be noted that the interface with the sensors is not limited to these interfaces. For example, Bluetooth (registered trademark) or Wi-Fi (registered trademark) may be used.

The FIFO write control unit 240 writes FIFO data into the FIFO memory 250. Each time the FIFO write control unit 240 acquires the sensor data Din1 or the like, the FIFO write control unit 240 refers to the current time RTC_CNT at that time, and generates a time stamp. The FIFO write control unit 240 also converts the format of sensor data as necessary, and supplies the converted format to the arithmetic processing unit 300. In the format conversion, the FIFO write control unit 240 divides the sensor data into byte units, and changes the order of the divided data, for example. Alternatively, the FIFO write control unit 240 performs bit shifting on the sensor data.

The FIFO write control unit 240 then receives sensor data Dout1 or the like processed by the arithmetic processing unit 300, and generates FIFO data including the processed sensor data and the time stamp for each sensor. The FIFO write control unit 240 writes the generated FIFO data into the FIFO memory 250.

In a case where the sensor data includes GPS location information and the reception time, the reception time, the time stamp (RTC_CNT) generated separately, and the sensor data are associated with one another and are then recorded. As a result, the sensor data of the GPS sensor and the other sensor data of the acceleration sensor 131 can be processed in synchronization with each other. For example, when the reception sensitivity of the GPS data becomes lower than a certain value at a certain time, the data processing unit 120 can acquire the current location from the GPS data at that time and the sensor data of the acceleration sensor 131 from that time.

Furthermore, the sensor data acquisition unit 200 collects sensor data from a plurality of sensors, and the data processing unit 120 processes the data. This is called sensor fusion. In this sensor fusion, it is necessary to process different pieces of sensor data obtained from the respective sensors on the same time axis. Therefore, recording the accurate acquisition time of each piece of sensor data is critical in achieving higher precision. To do so, it is necessary to generate a time stamp for each sensor data by referring to the time (RTC_CNT) generated by the same timing module (the real-time clock 111 or the like) between different sensors.

The FIFO memory 250 holds FIFO data by a FIFO method. Power is supplied to the interface of the FIFO memory 250 only when the FIFO write control unit 240 or the like accesses the FIFO memory 250, and power is not supplied unless access is made. Because of this, it is possible to reduce power consumption while holding FIFO data. It should be noted that the FIFO memory 250 is an example of the holding unit described in the claims.

The arithmetic processing unit 300 performs a predetermined arithmetic operation on sensor data. For example, the arithmetic processing unit 300 performs a process of decimating sensor data, a normalization process, and the like as necessary, and supplies processed sensor data to the FIFO write control unit 240. The arithmetic processing unit 300 also detects the presence/absence of movement of the electronic device 100 in accordance with sensor data, and generates the trigger signal TRIG indicating a detection result. For example, in a case where there is movement of the electronic device 100, the trigger signal TRIG is set at the high level for a predetermined pulse period. In a case where there is no movement, the trigger signal TRIG is set at the low level. The arithmetic processing unit 300 supplies the trigger signal TRIG to the power control unit 110.

Note that although the FIFO write control unit 240 writes FIFO data into the FIFO memory 250 regardless of the presence/absence of the trigger signal TRIG, the present technology is not limited to this arrangement. For example, the FIFO write control unit 240 may write FIFO data for a predetermined time when the trigger signal TRIG is output. As the FIFO write control unit 240 does not write FIFO data while the trigger signal TRIG is not output as described above, power consumption can be further reduced.

Alternatively, the FIFO write control unit 240 may perform writing on the FIFO memory 250 under a condition other than outputting of the trigger signal TRIG. For example, when the measured value of the acceleration sensor 131 exceeds the threshold value, the FIFO write control unit 240 may write the sensor data of the gyro sensor 132 for a predetermined time since that time.

Further, although the FIFO write control unit 240 uses the current time RTC_CNT acquired from the real-time clock 111 as a time stamp, the present technology is not limited to this arrangement. For example, the FIFO write control unit 240 may acquire a synchronization signal (a vertical synchronization signal or a horizontal synchronization signal) in a video signal generated by a reproduction device or the like outside the electronic device 100, and measure time in synchronization with the synchronization signal, to generate a time stamp. As a result, an application that processes video signals becomes capable of easily processing sensor data, and the affinity between such an application and sensor data can be enhanced.

[Example Configuration of the FIFO Memory]

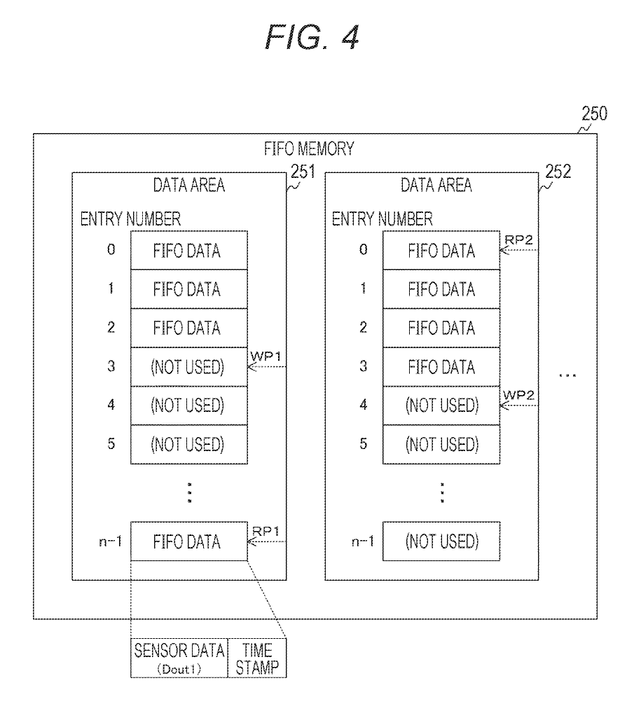

FIG. 4 is a diagram showing an example configuration of the FIFO memory 250. The FIFO memory 250 includes a plurality of data areas such as data areas 251 and 252. Different sensors from each other are associated with the respective data areas 251, and the FIFO data of the corresponding sensors are held therein. In the data area 251, a plurality of entries are provided, each of which holds one set of FIFO data. Likewise, a plurality of entries are provided for the data areas other than the data area 251. Each set of the FIFO data includes sensor data and a time stamp.

The FIFO write control unit 240 and the data processing unit 120 hold a write pointer and a read pointer for each data area. The write pointer indicates the position of the entry to which FIFO data is to be added, and the read pointer indicates the position of the entry from which FIFO data is to be retrieved.

Before FIFO data is written into a data area (251 or another), the FIFO write control unit 240 determines whether the number of sets of FIFO data in the data area has reached the total number of entries (in other words, the buffer is full). If the buffer is full, the FIFO write control unit 240 discards the acquired FIFO data without writing it. If the buffer is not full, on the other hand, the FIFO write control unit 240 refers to the write pointer corresponding to the data area, and writes the FIFO data into the entry indicated by the write pointer. The FIFO write control unit 240 then updates (increments, for example) the corresponding write pointer.

Note that in a case where the buffer is full, the FIFO write control unit 240 discards the FIFO data without writing it as described above. However, the FIFO data may not be discarded but be written. In that case, the FIFO write control unit 240 updates both the write pointer and the read pointer after writing the FIFO data into the entry indicated by the write pointer. Alternatively, a register set value may be set to indicate whether data is to be discarded.

Meanwhile, before FIFO data is to be retrieved from a data area (251 or another), the data processing unit 120 refers to the read pointer corresponding to the data area, and reads the FIFO data from the entry indicated by the read pointer. The data processing unit 120 then updates (increments, for example) the corresponding read pointer.

[Example Configuration of the Arithmetic Processing Unit]

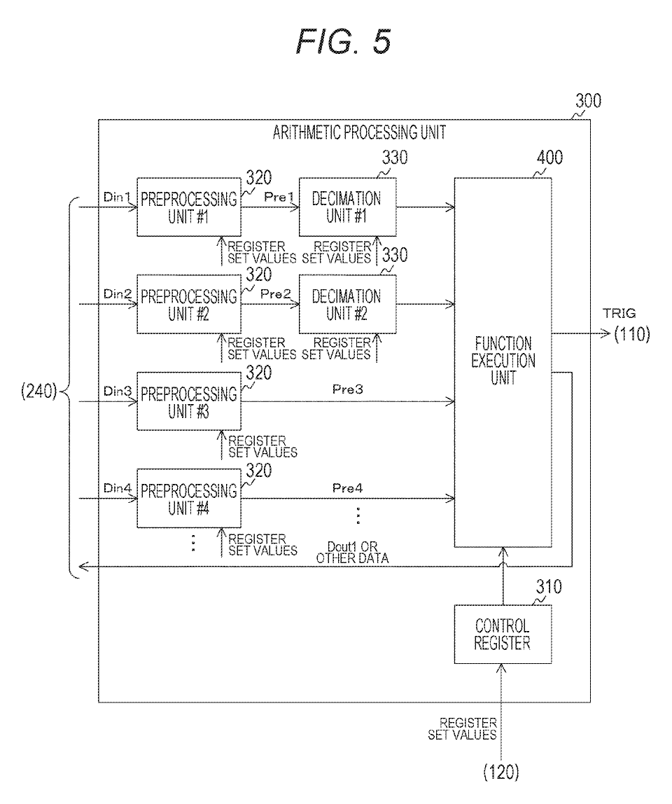

FIG. 5 is a block diagram showing an example configuration of the arithmetic processing unit 300 according to the first embodiment. The arithmetic processing unit 300 includes a control register 310, a predetermined number of preprocessing units 320, a plurality of decimation units 330, and a function execution unit 400.

The register setting values are written into the control register 310 by the data processing unit 120.

The preprocessing units 320 are provided for the respective sensors. For example, if there are ten sensors, ten preprocessing units 320 are provided. Also, a decimation unit 330 is provided for each current sensor to be subjected to sensor data decimation. For example, in a case where the sensor data of two sensors among ten sensors is to be decimated while decimation is not to be performed on the remaining eight sensors, two decimation units 330 are provided.

The preprocessing units 320 perform preprocessing, which is processing such as offset addition or amplification, on the sensor data of the corresponding sensors. The preprocessing unit 320 corresponding to the current sensor to be subjected to decimation supplies processed sensor data to the decimation unit 330. On the other hand, the preprocessing unit 320 corresponding to a sensor not to be subjected to decimation supplies processed sensor data to the function execution unit 400.

For example, preprocessing units #1 through #10 are provided as the preprocessing units 320. The preprocessing units #1 and #2 supply processed data as preprocessed data Pre1 and Pre2 to the corresponding decimation units 330. The preprocessing units #3 through #10 supply processed data as preprocessed data Pre3 through Pre10 to the function execution unit 400.

The decimation units 330 perform decimation on the sensor data of the corresponding sensors as necessary. For example, a process of discarding m₂ (m₂ being an integer smaller than m₁) sets of data among m₁ (m₁ being an integer) sets of data is performed as a decimation process. The decimation units 330 supply sensor data subjected to decimation to the function execution unit 400.

The function execution unit 400 performs a function calculation of processing on a predetermined number (three, for example) of sets of data among the sensor data subjected to decimation or the sensor data not subjected to decimation. The function execution unit 400 supplies sensor data subjected to the calculation, to the FIFO write control unit 240. The function execution unit 400 also generates the trigger signal TRIG in accordance with the sensor data, and supplies the trigger signal TRIG to the power control unit 110.

Note that although two decimation units 330 are provided in this example, one decimation unit 330 or more than two decimation units 330 may be provided in accordance with the number of sensors to be subjected to decimation.

[Example Configuration of a Preprocessing Unit]

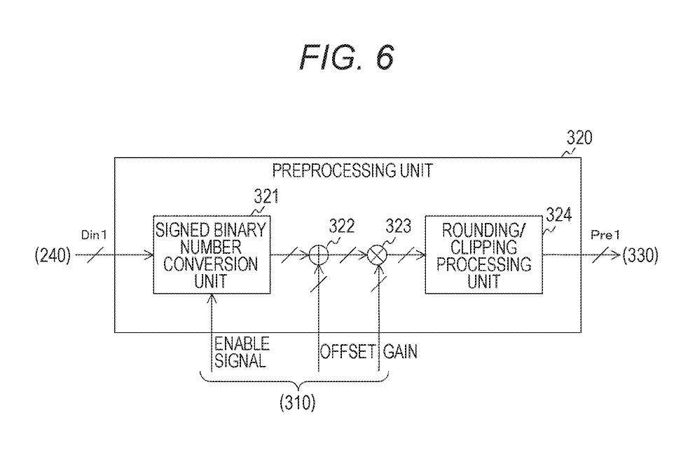

FIG. 6 is a block diagram showing an example configuration of a preprocessing unit 320 according to the first embodiment. The preprocessing unit 320 includes a signed binary number conversion unit 321, an adder 322, a multiplier 323, and a rounding/clipping processing unit 324.

The signed binary number conversion unit 321 converts the format of sensor data into a signed binary number in accordance with an enable signal, and supplies the signed binary number to the adder 322. This enable signal indicates whether to perform conversion to a signed binary number, and is set in the control register 310.

The adder 322 adds a predetermined offset to the data from the signed binary number conversion unit 321, and supplies the resultant data to the multiplier 323. The value of this offset is set in the control register 310.

The multiplier 323 multiplies the data from the adder 322 by a predetermined gain, and supplies the resultant data to the rounding/clipping processing unit 324. The value of this gain is set in the control register 310.

The rounding/clipping processing unit 324 performs a rounding operation and a clipping process on the data from the multiplier 323, and outputs the processed data as preprocessed data Pre1. Here, the clipping process is a process of limiting the value of data within a predetermined range. For example, in the clipping process, the rounding/clipping processing unit 324 determines whether the value of the data exceeds a predetermined upper limit value. If the value of the data exceeds the upper limit value, the rounding/clipping processing unit 324 outputs the upper limit value. If the value of the data does not exceed the upper limit value, the rounding/clipping processing unit 324 outputs the value of the data without any change.

[Example Configuration of a Decimation Unit]

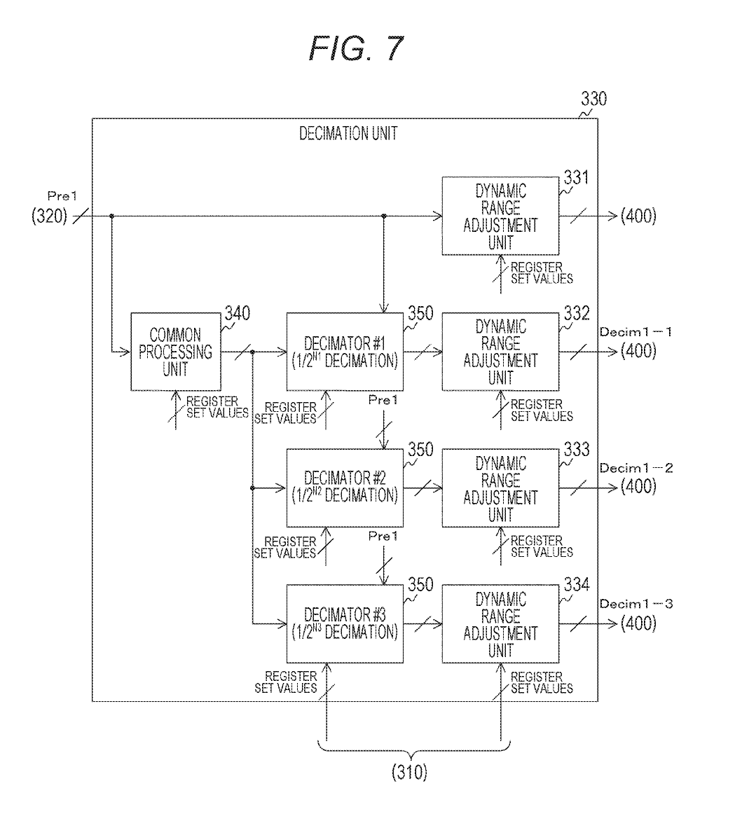

FIG. 7 is a block diagram showing an example configuration of a decimation unit 330 according to the first embodiment. The decimation unit 330 includes a common processing unit 340, three decimators 350, and dynamic range adjustment units 331, 332, 333, and 334.

The common processing unit 340 performs predetermined processing required before decimation by the respective decimators 350 on the preprocessed data Pre1, and supplies the processed data to all the decimators 350.

The decimators 350 perform a process of decimating the preprocessed data Pre1 at a predetermined decimation rate. Different decimation rates are set for the three respective decimators 350. Here, a decimation rate indicates the ratio of the number of sets of data to be discarded (decimated) to a certain number of sets of sensor data. For example, the decimation rate in a case where one of 2^{N} (N being an integer) sets of data is to be discarded is represented by ½^{N}. A decimator #1, a decimator #2, and a decimator #3 are provided as the decimators 350, and the decimator #1 supplies the data subjected to the decimation, to the dynamic range adjustment unit 332. The decimators #2 and #3 supply the data subjected to the decimation, to the dynamic range adjustment units 333 and 334.

The dynamic range adjustment unit 331 adjusts the dynamic range of the preprocessed data Pre1, and supplies the resultant data to the function execution unit 400. Meanwhile, the dynamic range adjustment unit 332 adjusts the dynamic range of the data from the decimator #1, and supplies the resultant data as decimated data Decim1-1 to the function execution unit 400. The dynamic range adjustment units 333 and 334 adjust the dynamic ranges of the data from the decimators #2 and #3 and supply the resultant data as decimated data Decim1-2 and Decim1-3 to the function execution unit 400. The adjustment amounts for these dynamic ranges are set in the control register 310.

Note that although the three decimators 350 are provided in the decimation unit 330 in this example, any other number of decimators 350 may be provided.

[Example Configuration of a Common Processing Unit]

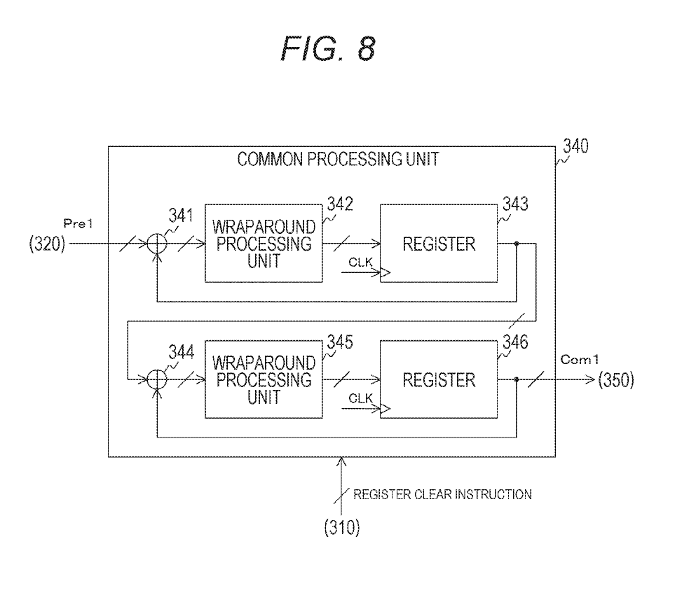

FIG. 8 is a block diagram showing an example configuration of a common processing unit 340 according to the first embodiment. The common processing unit 340 includes adders 341 and 344, wraparound processing units 342 and 345, and registers 343 and 346.

The adder 341 adds the preprocessed data Pre1 to data from the register 343, and supplies the resultant data to the wraparound processing unit 342.

If an addition result from the adder 341 exceeds the maximum value and overflows, the wraparound processing unit 342 performs a wraparound process that is a process of restoring the result to the minimum value. The wraparound processing unit 342 causes the register 343 to hold the processed data.

The register 343 holds the data from the wraparound processing unit 342 in synchronization with a predetermined clock signal CLK, and outputs the data to the adders 341 and 344.

The adder 344 adds the data from the register 343 to data from the register 346, and supplies the resultant data to the wraparound processing unit 345.

The wraparound processing unit 345 performs a wraparound process on the addition result from the adder 344. The wraparound processing unit 345 causes the register 346 to hold the processed data.

The register 343 holds the data from the wraparound processing unit 345 in synchronization with the predetermined clock signal CLK, and supplies the data as processed data Com1 to the decimators 350.

[Example Configuration of a Decimator]

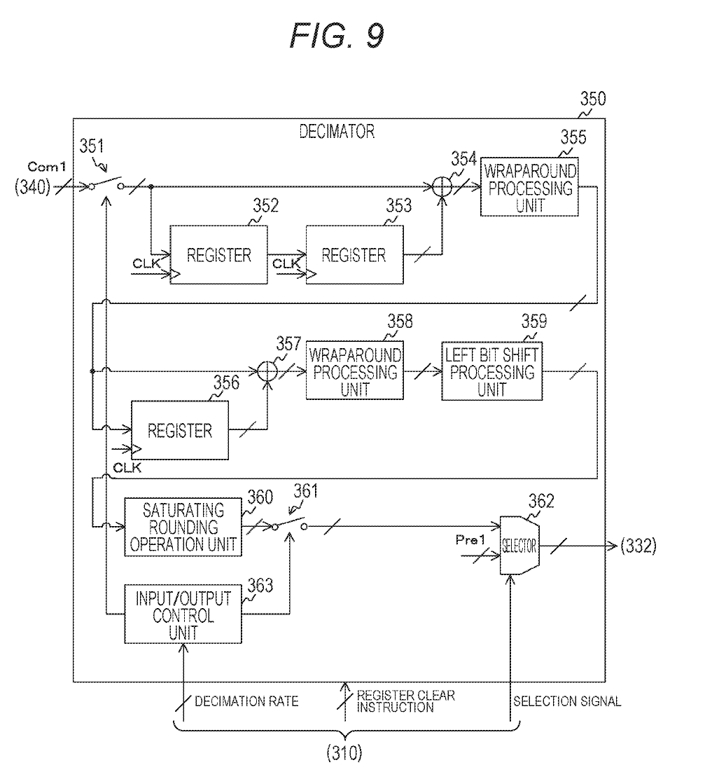

FIG. 9 is a block diagram showing an example configuration of a decimator 350 according to the first embodiment. The decimator 350 includes switches 351 and 361, registers 352, 353, and 356, adders 354 and 357, and wraparound processing units 355 and 358. The decimator 350 also includes a left bit shift processing unit 359, a saturating rounding operation unit 360, a selector 362, and an input/output control unit 363.

The switch 351 opens and closes the path under the control of the input/output control unit 363. One end of the switch 351 is connected to the common processing unit 340, and the other end is connected to the register 352 and the adder 354.

The registers 352 and 353 delay the processed data Com1 from the switch 351 by a certain time, and outputs the resultant data to the adder 354.

The adder 354 adds the data from the register 353 to the processed data Com1 from the switch 351, and supplies the resultant data to the wraparound processing unit 355.

The wraparound processing unit 355 performs a wraparound process on the addition result from the adder 354, and supplies the result to the register 356 and the adder 357.

The register 356 delays the data from the wraparound processing unit 355, and outputs the resultant data to the adder 357.

The above described registers 352, 353, and 356 are initialized in accordance with a register clear instruction.

The adder 357 adds the data from the wraparound processing unit 355 to the data from the register 356, and supplies the resultant data to the wraparound processing unit 358.

The wraparound processing unit 358 performs a wraparound process on the addition result from the adder 357, and supplies the result to the left bit shift processing unit 359.

The left bit shift processing unit 359 performs left bit shifting on data subjected to a wraparound process, by a certain shift amount. The left bit shift processing unit 359 supplies the shifted data to the saturating rounding operation unit 360.

The saturating rounding operation unit 360 performs a rounding operation so that the shifted data is saturated at a time of overflow. The saturating rounding operation unit 360 supplies the data subjected to the operation to the switch 361.

The switch 361 opens and closes the path under the control of the input/output control unit 363. One end of the switch 361 is connected to the saturating rounding operation unit 360, and the other end is connected to the selector 362.

The selector 362 selects the preprocessed data Pre1 or the data from the switch 361 in accordance with a selection signal, and supplies the selected data to the dynamic range adjustment unit 332.

The input/output control unit 363 controls the switches 351 and 361 in accordance with the decimation rate. For example, in a case where the decimation rate is ½, the input/output control unit 363 switches both the switches 351 and 361 from one of an opened state and a closed state to the other every time the sampling period has elapsed. Furthermore, in a case where the decimation rate is ¼, the input/output control unit 363 closes both of the switches 351 and 361 over three cycles out of four cycles, and opens both of the switches 351 and 361 during the remaining one cycle.

The decimation rate, the register clear instruction, and the selection signal are all set in the control register 310.

[Example Configuration of the Function Execution Unit]

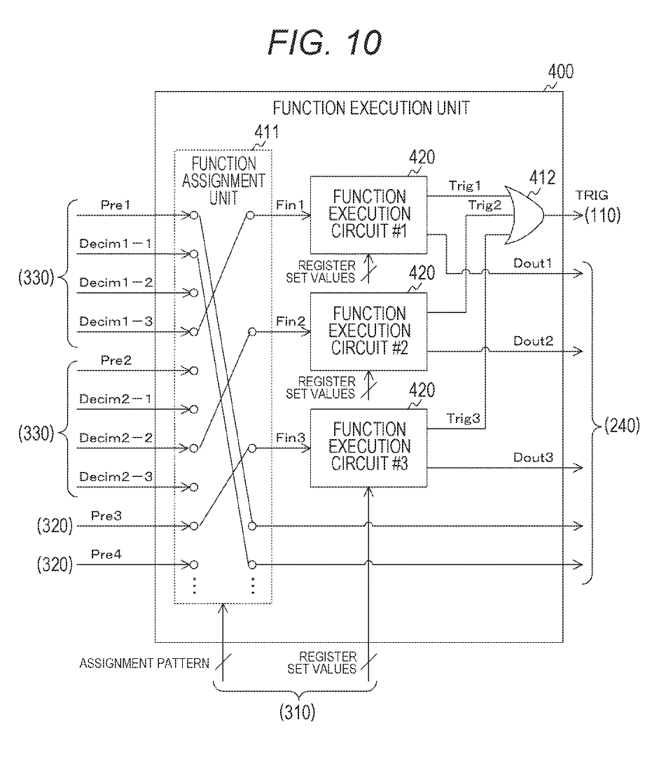

FIG. 10 is a block diagram showing an example configuration of the function execution unit 400 according to the first embodiment. The function execution unit 400 includes a function assignment unit 411, a plurality of function execution circuits 420, and an OR (logical add) gate 412. For example, function execution circuits #1 through #3 are provided as the function execution circuits 420. Note that the number of the function execution circuits 420 is not necessarily three, and may be a number other than three.

The function assignment unit 411 assigns the function execution circuits 420 to the sets of data from the respective decimation units 330 and the respective preprocessing units 320. In an example case, the decimation units #1 and #2 output preprocessed data and three sets of decimated data, and each of the preprocessing units #3 through #10 outputs one set of preprocessed data. In this case, ten sets of preprocessed data and six sets of decimated data are input to the function assignment unit 411, and the function assignment unit 411 can assign the function execution circuits #1 through #3 to three sets of the input data. Only one function execution circuit is assigned to one set of data. The function assignment unit 411 supplies the assigned data as input data Fin1 through Fin3 to the function execution circuits #1 through #3. Note that the assignment pattern indicating to which data the function execution circuits #1 through #3 are to be assigned is set in the control register 310.

The function execution circuits 420 each execute a predetermined function operation on data input from the function assignment unit 411. The function execution circuits #1 through #3 supply the data subjected to the operation as sensor data Dout1 through Dout3 to the FIFO write control unit 240. The function execution circuits #1 through #3 also detect the presence/absence of movement of the electronic device 100 in accordance with input data, and generate trigger signals Trig1 through Trig3 indicating detection results.

The OR gate 412 outputs the logical sum of the trigger signals Trig1 through Trig3 as the trigger signal TRIG to the power control unit 110.

Note that in a case where only one function execution circuit 420 is provided, the OR gate 412 is unnecessary.

[Example Configuration of a Function Execution Circuit]

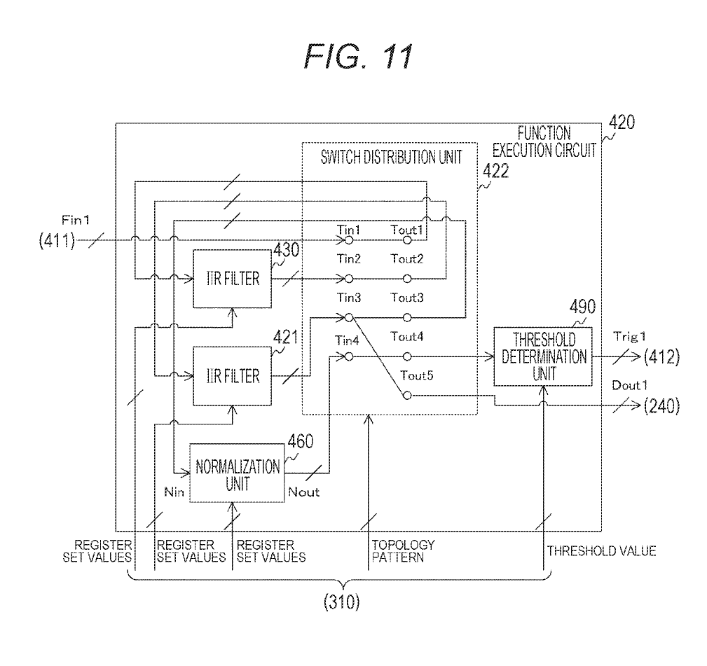

FIG. 11 is a block diagram showing an example configuration of a function execution circuit 420 according to the first embodiment. The function execution circuit 420 includes IIR filters 430 and 421, a normalization unit 460, a threshold determination unit 490, and a switch distribution unit 422.

The switch distribution unit 422 divides one of the sets of data from the function assignment unit 411, the IIR filter 430, the IIR filter 421, and the normalization unit 460 into two, and switches output destinations thereof. The switch distribution unit 422 includes input terminals Tin1 through Tin4, and output terminals Tout1 through Tout5. Input data Fin1 is input to the input terminal Tin1, and data from the IIR filter 430 is input to the input terminal Tin2. Furthermore, data from the IIR filter 421 is input to the input terminal Tin3, and data from the normalization unit 460 is input to the input terminal Tin4.

Further, data output from the output terminal Tout1 is input to the IIR filter 430, and data output from the output terminal Tout2 is input to the IIR filter 421. Data output from the output terminal Tout3 is input to the normalization unit 460, and data output from the output terminal Tout4 is input to the threshold determination unit 490. Data from the output terminal Tout5 is input as the sensor data Dout1 to the FIFO write control unit 240.

One of these input terminals Tin1 through Tin4 can be connected to two output terminals, for example. Further, the remaining three input terminals can be connected to different output terminals in one-to-one correspondence, for example. The switch distribution unit 422 can be formed with a multiplexer or a demultiplexer, for example. The pattern in which the switch distribution unit 422 connects the terminals is set as a topology pattern in the control register 310. This topology pattern is set with 4-bit data, for example. It should be noted that the switch distribution unit 422 is an example of the connection control unit described in the claims.

The IIR filter 430 performs a predetermined filtering process on the data from the output terminal Tout2, and outputs the resultant data to the input terminal Tin2. For example, a process of passing a signal of a low frequency band below a certain frequency, a process of passing a signal of a high frequency band above a certain frequency, and the like are performed.

The IIR filter 421 performs a predetermined filtering process on the data from the output terminal Tout3, and outputs the resultant data to the input terminal Tin3. It should be noted that the IIR filters 430 and 421 are an example of the filtering unit described in the claims.

The normalization unit 460 performs a predetermined normalization process on the data from the output terminal Tout4, and outputs the resultant data to the input terminal Tin4.

The threshold determination unit 490 generates the trigger signal Trig1 in accordance with the data from the output terminal Tout4 and a predetermined threshold value, and outputs the trigger signal Trig1 to the OR gate 412.

Note that although the function execution circuit 420 performs filtering processes with the IIR filters 430 and 421, and a normalization process with the normalization unit 460 in this example, the function execution circuit 420 may further perform some other process. For example, the function execution circuit 420 may further perform linear multiplication and an add operation to perform part of a deep learning process.

[Example Configuration of an IIR Filter]

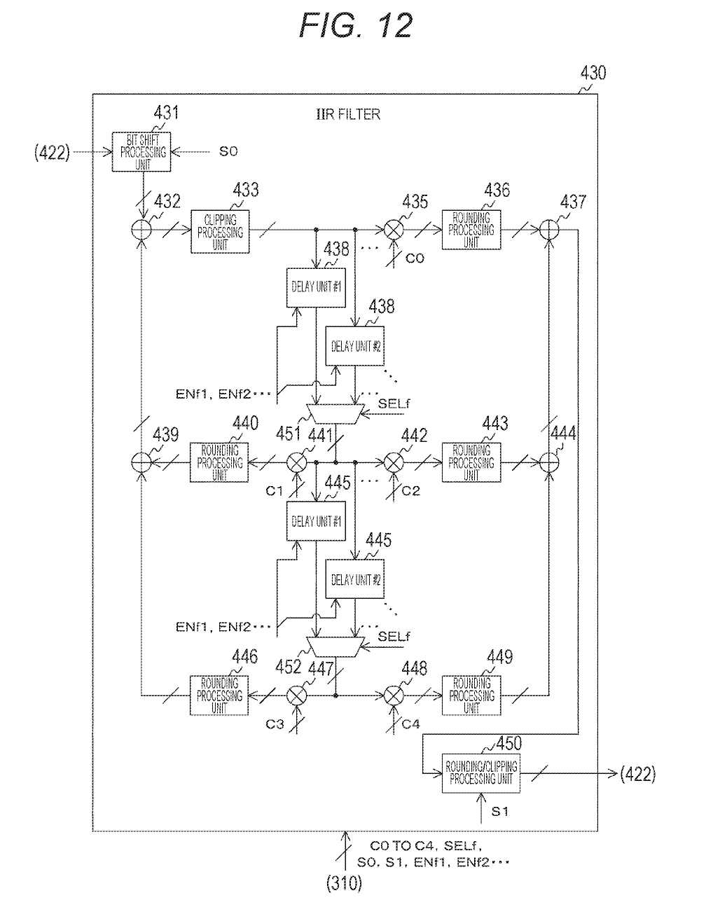

FIG. 12 is a block diagram showing an example configuration of an IIR filter 430 according to the first embodiment. The IIR filter 430 includes a bit shift processing unit 431, adders 432, 437, 439, and 444, a clipping processing unit 433, a plurality of delay units 438, and multipliers 435, 441, 442, 447, and 448. The IIR filter 430 also includes rounding processing units 436, 440, 443, 446, and 449, a rounding/clipping processing unit 450, and selectors 451 and 452.

The bit shift processing unit 431 performs a bit shift process on data from the switch distribution unit 422, and supplies the resultant data to the adder 432. The shift amount S0 in the bit shifting is set in the control register 310. The shift amount S0 is a signed integer, and the sign of S0 indicates the shift direction.

The adder 432 adds an addition result from the adder 439 to data from the bit shift processing unit 431, and supplies the resultant data to the clipping processing unit 433.

The clipping processing unit 433 performs a clipping process on the addition result from the adder 432, and outputs the result to the respective delay units 438 and the multiplier 435.

The delay units 438 delay the data from the clipping processing unit 433 in accordance with an enable signal, and supply the resultant data to the selector 451. Delay units #1, #2, and the like are provided as the delay units 438. An enable signal ENf1 is input to the delay unit #1, and an enable signal ENf2 is input to the delay unit #2. To enable a delay unit 438, the enable signal is set at the high level, for example. To disable a delay unit 438, the enable signal is set at the low level.

The multiplier 435 multiplies the data from the clipping processing unit 433 by a predetermined coefficient C0, and supplies the resultant data to the rounding processing unit 436.

The rounding processing unit 436 performs a rounding operation on the multiplication result from the multiplier 435, and supplies the result to the adder 437.

The adder 437 adds the data from the rounding processing unit 436 to an addition result from the adder 444, and supplies the resultant data to the rounding/clipping processing unit 450.

The selector 451 selects one of the sets of data from the plurality of delay units 438 in accordance with a selection signal SELf, and supplies the selected data to the multipliers 441 and 442 and a plurality of delay units 445.

The multiplier 441 multiplies the data from the selector 451 by a predetermined coefficient C1, and supplies the resultant data to the rounding processing unit 440.

The rounding processing unit 440 performs a rounding operation on the multiplication result from the multiplier 441, and supplies the result to the adder 439.

The adder 439 adds the sets of data from the rounding processing units 440 and 446 to each other, and supplies the result to the adder 432.

The multiplier 442 multiplies the data from the selector 451 by a predetermined coefficient C2, and supplies the resultant data to the rounding processing unit 443.

The rounding processing unit 443 performs a rounding operation on the multiplication result from the multiplier 442, and supplies the result to the adder 444.

The adder 444 adds the sets of data from the rounding processing units 443 and 449 to each other, and supplies the result to the adder 437.

The delay units 445 delay the data from the clipping processing unit 433 in accordance with an enable signal, and supply the resultant data to the selector 452.

The selector 452 selects one of the sets of data from the plurality of delay units 445 in accordance with the selection signal SELf, and supplies the selected data to the multipliers 447 and 448.

The multiplier 447 multiplies the data from the selector 452 by a predetermined coefficient C3, and supplies the resultant data to the rounding processing unit 446.

The rounding processing unit 446 performs a rounding operation on the multiplication result from the multiplier 447, and supplies the result to the adder 439.

The multiplier 448 multiplies the data from the selector 452 by a predetermined coefficient C4, and supplies the resultant data to the rounding processing unit 449.

The rounding processing unit 449 performs a rounding operation on the multiplication result from the multiplier 448, and supplies the result to the adder 444.

The rounding/clipping processing unit 450 performs a rounding operation and a clipping process on the addition result from the adder 437, and outputs the result to the switch distribution unit 422.

The above mentioned shift amount S0, the limit range S1 in the clipping process, the coefficients C0 through C4, the enable signal, and the selection signal SELf are set in the control register 310.

As the coefficients C0 through C4 are set as appropriate, the IIR filter 430 functions as a low-pass filter or a high-pass filter. Further, each of the delay units 438 holds data in synchronization with the timing of sampling the current sensor data to be processed. As the plurality of delay units 438 can hold data at different timings from one another in accordance with an enable signal, each of these delay units can process a plurality of sets of sensor data at different sampling rates with the single IIR filter 430.

[Example Configuration of a Normalization Unit]

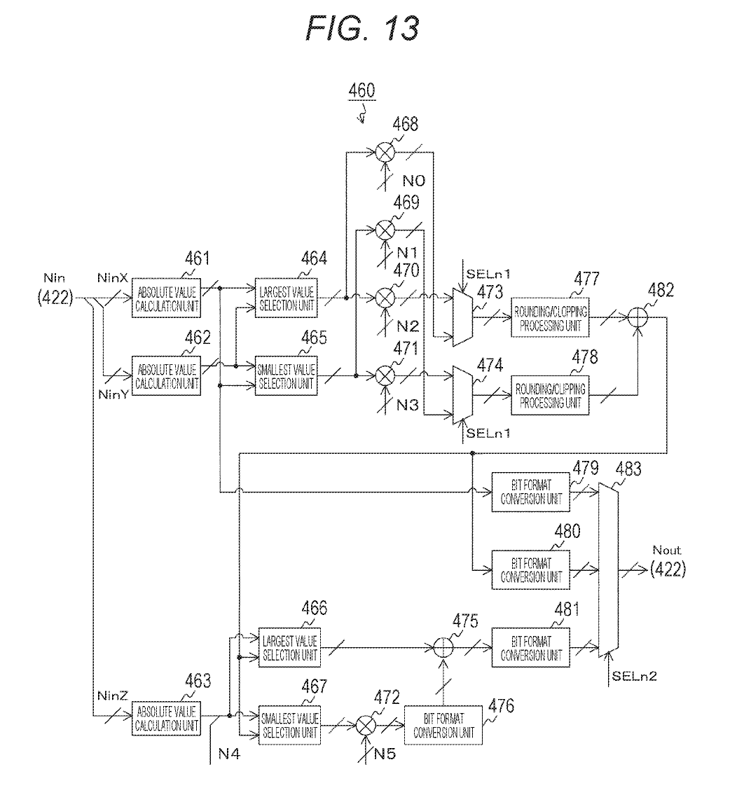

FIG. 13 is a block diagram showing an example configuration of a normalization unit 460 according to the first embodiment. The normalization unit 460 includes absolute value calculation units 461, 462, and 463, largest value selection units 464 and 466, smallest value selection units 465 and 467, multipliers 468, 469, 470, 471, and 472, and selectors 473, 474, and 483. The normalization unit 460 also includes adders 475 and 482, bit format conversion units 476, 479, 480, and 481, and rounding/clipping processing units 477 and 478.

Here, the sensor data Nin to be input to the normalization unit 460 includes at least one of an X-axis measurement value NinX, a Y-axis measurement value NinY, and a Z-axis measurement value NinZ. The X-axis measurement value NinX is a measurement value on the X-axis among the X-axis, Y-axis, and Z-axis, which are perpendicular to one another. The Y-axis measurement value NinY and NinZ are measurement values on the Y-axis and the Z-axis. It should be noted that the type and the number of measurement values included in the sensor data vary depending on the sensor type. For example, the sensor data of the acceleration sensor 131 includes measurement values of acceleration rates on the X-axis, the Y-axis, and the Z-axis, and the sensor data of the atmospheric pressure sensor 133 includes only one measurement value of atmospheric pressure.

The absolute value calculation unit 461 calculates the absolute value of the X-axis measurement value NinX. The absolute value calculation unit 461 outputs the calculated value to the largest value selection units 464 and 466, the smallest value selection units 465 and 467, and the bit format conversion unit 479.

The absolute value calculation unit 462 calculates the absolute value of the Y-axis measurement value NinY. The absolute value calculation unit 462 outputs the calculated value to the largest value selection unit 464 and the smallest value selection unit 465.

The absolute value calculation unit 463 calculates the absolute value of the Z-axis measurement value NinZ. The absolute value calculation unit 463 outputs the calculated value to the largest value selection unit 466 and the smallest value selection unit 467.

The largest value selection unit 464 selects the largest value of the absolute values calculated by the absolute value calculation units 461 and 462, and supplies the selected value to the multipliers 468 and 470.

The smallest value selection unit 465 selects the largest value of the absolute values calculated by the absolute value calculation units 461 and 462, and supplies the selected value to the multipliers 469 and 471.

The multiplier 468 multiplies the largest value from the largest value selection unit 464 by a predetermined coefficient NO, and supplies the resultant value to the selector 473. The multiplier 469 multiplies the smallest value from the smallest value selection unit 465 by a predetermined coefficient N1, and supplies the resultant value to the selector 474. The multiplier 470 multiplies the largest value from the largest value selection unit 464 by a predetermined coefficient N2, and supplies the resultant value to the selector 473. The multiplier 471 multiplies the smallest value from the smallest value selection unit 465 by a predetermined coefficient N3, and supplies the resultant value to the selector 474.

The selector 473 selects one of the multiplication results from the multipliers 468 and 470 in accordance with a selection signal SELn1, and supplies the selected result to the rounding/clipping processing unit 477. The selector 474 selects one of the multiplication results from the multipliers 469 and 471 in accordance with the selection signal SELn1, and supplies the selected result to the rounding/clipping processing unit 478.

The rounding/clipping processing unit 477 performs a rounding process and a clipping process on the data from the selector 473, and supplies the resultant data to the adder 482. The rounding/clipping processing unit 478 performs a rounding process and a clipping process on the data from the selector 474, and supplies the resultant data to the adder 482.

The adder 482 adds the sets of data from the rounding/clipping processing units 477 and 478 to each other, and supplies the result to the bit format conversion unit 480, the largest value selection unit 466, and the smallest value selection unit 467.

The largest value selection unit 466 selects the largest value of the data obtained by adding N4 to the absolute value calculated by the absolute value calculation unit 463 and the addition result from the adder 482, and outputs the selected value to the adder 475.

The smallest value selection unit 467 selects the smallest value of the data obtained by adding N4 to the absolute value calculated by the absolute value calculation unit 463 and the addition result from the adder 482, and outputs the selected value to the multiplier 472.

The multiplier 472 multiplies the smallest value from the smallest value selection unit 467 by a predetermined coefficient N5, and supplies the result to the bit format conversion unit 476.

The bit format conversion unit 476 converts the format of the data from the multiplier 472, and supplies the resultant data to the adder 475.

The adder 475 adds the data from the bit format conversion unit 476 to the largest value from the largest value selection unit 466, and supplies the result to the bit format conversion unit 481.

The bit format conversion unit 479 converts the format of the data from the absolute value calculation unit 461, and supplies the resultant data to the selector 483. The bit format conversion unit 480 converts the format of the data from the adder 482, and supplies the resultant data to the selector 483. The bit format conversion unit 481 converts the format of the data from the adder 475, and supplies the resultant data to the selector 483.

The selector 483 selects one of the bit format conversion units 479, 480, and 481 in accordance with a selection signal SELn2, and outputs the selection result to the switch distribution unit 422. In a case where the sensor data includes only the X-axis measurement value NinX, the data from the bit format conversion unit 479 is selected. Furthermore, in a case where the sensor data includes only the X-axis measurement value NinX and the Y-axis measurement value NinY, however, the data from the bit format conversion unit 480 is selected. In a case where the sensor data includes all of the X-axis measurement value NinX, the Y-axis measurement value NinY, and the Z-axis measurement value NinZ, the data from the bit format conversion unit 481 is selected.

The above mentioned coefficients NO through N5, and the selection signals SELn1 and SELn2 are set in the control register 310. Further, with the above configuration, sensor data is normalized to the square root of the sum of squares of respective measurement values on the X-axis, the-Y axis, and the-Z axis. In other words, a vector expressed by measurement values on the X-axis, the Y-axis, and the Z-axis is converted into a scalar.

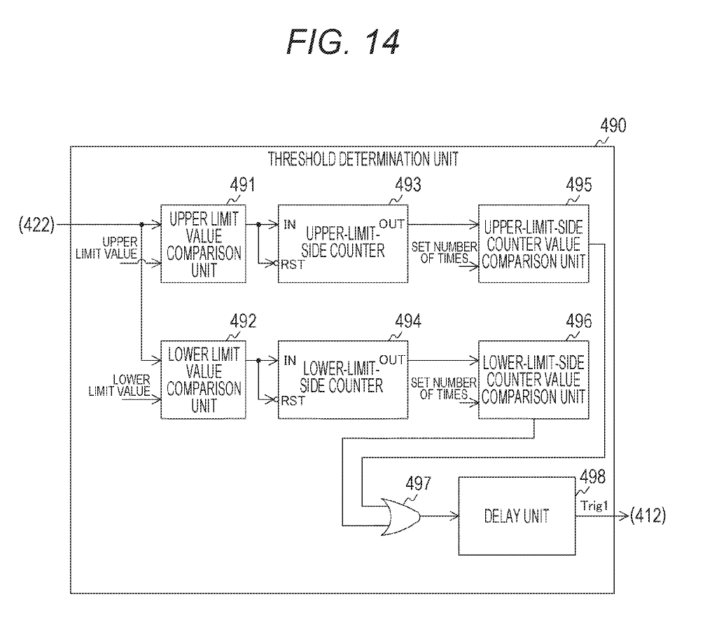

FIG. 14 is a block diagram showing an example configuration of a threshold determination unit 490 according to the first embodiment. The threshold determination unit 490 includes an upper limit value comparison unit 491, an upper-limit-side counter 493, an upper-limit-side counter value comparison unit 495, a lower limit value comparison unit 492, a lower-limit-side counter 494, a lower-limit-side counter value comparison unit 496, an OR gate 497, and a delay unit 498.

The upper limit value comparison unit 491 compares the value of sensor data with a predetermined upper limit value. The upper limit value comparison unit 491 outputs a comparison result to the upper-limit-side counter 493. For example, in a case where sensor data exceeds the upper limit value, a high-level comparison result is output. In a case where sensor data does not exceed the upper limit value, a low-level comparison result is output.

The upper-limit-side counter 493 counts the number of times sensor data exceeding the upper limit value has been successively acquired. The upper-limit-side counter 493 counts a counter value UCNT every time a high-level comparison result is input, and sets the counter value UCNT to the initial value when a low-level comparison result is input. The upper-limit-side counter 493 supplies the counter value UCNT to the upper-limit-side counter value comparison unit 495.

The upper-limit-side counter value comparison unit 495 compares the counter value UCNT with a predetermined set number of times. The upper-limit-side counter value comparison unit 495 supplies a comparison result to the OR gate 497. For example, in a case where the counter value UCNT exceeds the set number of times, a high-level comparison result is output. In a case where the counter value UCNT is equal to or smaller than the set number of times, a low-level comparison result is output.

The lower limit value comparison unit 492 compares the value of sensor data with a predetermined lower limit value. The lower limit value comparison unit 492 outputs a comparison result to the lower-limit-side counter 494. For example, in a case where sensor data is lower than the lower limit value, a high-level comparison result is output. In a case where sensor data is not lower than the lower limit value, a low-level comparison result is output.

The lower-limit-side counter 494 counts the number of times sensor data having a lower value than the lower limit value has been successively acquired. The lower-limit-side counter 494 counts a counter value LCNT every time a high-level comparison result is input, and sets the counter value LCNT to the initial value when a low-level comparison result is input. The lower-limit-side counter 494 supplies the counter value LCNT to the lower-limit side counter value comparison unit 496.

The lower-limit-side counter value comparison unit 496 compares the counter value LCNT with a predetermined set number of times. The upper-limit-side counter value comparison unit 495 and the lower-limit-side counter value comparison unit 496 may compare the respective counter values with the same number of times or different numbers of times. The lower-limit-side counter value comparison unit 496 supplies a comparison result to the OR gate 497. For example, in a case where the counter value LCNT exceeds the set number of times, a high-level comparison result is output. In a case where the counter value LCNT is equal to or smaller than the set number of times, a low-level comparison result is output.

The OR gate 497 outputs a signal of the logical sum of the respective comparison results from the upper-limit-side counter value comparison unit 495 and the lower-limit-side counter value comparison unit 496, to the delay unit 498.

The delay unit 498 delays a signal output from the OR gate 497 over a delay time T_{delay}, and outputs the delayed signal as the trigger signal Trig1 to the OR gate 412.

In the above configuration, if sensor data having a value outside the certain range from the lower limit value to the upper limit value has been successively acquired a set number of times, the trigger signal Trig1 is generated after the delay time T_{delay} has elapsed.

Note that although the threshold determination unit 490 compares sensor data with both the lower limit value and the upper limit value, sensor data may be compared with only one of the upper and lower limit values.

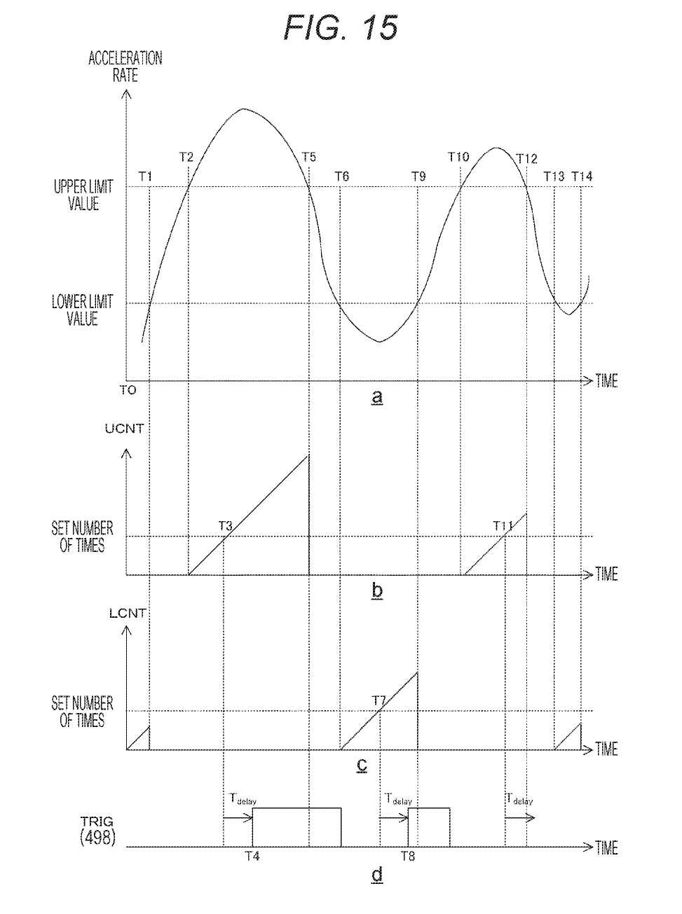

FIG. 15 is a graph showing an example of fluctuations of the acceleration rate, the count values, and a trigger signal in the first embodiment. In the graph, “a” shows an example of the fluctuation of the acceleration rate measured by the acceleration sensor 131 when the user walked. Also, in “a” of the graph, the ordinate axis indicates the acceleration rate, and the abscissa axis indicates time. As shown in “a” of the graph, the acceleration rate repeatedly increases and decreases when the user is walking.

In FIG. 15, “b” is a graph showing an example of the fluctuation of the counter value UCNT. Also, in the graph “b”, the ordinate axis indicates the counter value UCNT, and the abscissa axis indicates time. When a higher acceleration rate than the upper limit value was measured during the period from time T2 till time T5, the counter value UCNT was incremented during that period. Because a higher acceleration rate than the upper limit value was also measured during the period from time T10 till time T12, the counter value UCNT was incremented likewise during that period.

In FIG. 15, “c” is a graph showing an example of the fluctuation of the counter value LCNT. Also, in the graph “c”, the ordinate axis indicates the counter value LCNT, and the abscissa axis indicates time. When a lower acceleration rate than the lower limit value was measured during the period from time T0 till time T1, the counter value LCNT was incremented during that period. Because a lower acceleration rate than the lower limit value was also measured during the period from time T6 till time T9, the counter value LCNT was incremented likewise during that period.

In FIG. 15, “d” is a graph showing an example of the fluctuation of the trigger signal TRIG. At time T3 when the count value UCNT becomes greater than the set number of times, the trigger signal TRIG is generated at time T4 when the delay time T_{delay} has elapsed since time T3. Also, at time T7 when the count value LCNT becomes greater than the set number of times, the trigger signal TRIG is generated at time T8 when the delay time T_{delay} has elapsed since time T7.

If the threshold determination unit 490 is designed to determine whether sensor data has a value outside a certain range, the trigger signal TRIG is repeatedly switched on and off when the sensor data fluctuates around a boundary value of the range, and electric power is unnecessarily consumed. However, the threshold determination unit 490 determines whether sensor data having a value outside the certain range has been successively acquired the set number of times, the above unnecessary operation can be avoided.

The threshold determination unit 490 also generates the trigger signal TRIG when the delay time has elapsed. Accordingly, the FIFO write control unit 240 can cause the FIFO memory 250 to hold the data measured during the delay time. Here, the FIFO memory 250 preferably has such a capacity as to be able to hold FIFO data measured over a longer period than the delay time. With this capacity, the FIFO memory 250 can hold FIFO data before and after the times at which the counter values UCNT and LCNT exceed the set number of times.

Note that although the threshold determination unit 490 generates the trigger signal TRIG from a result of comparison between a sensor data value and a threshold value, the threshold determination unit 490 is not necessarily designed like that. For example, the threshold determination unit 490 may generate the trigger signal TRIG if the number of sets of sensor data written in the FIFO memory 250 exceeds a threshold value.

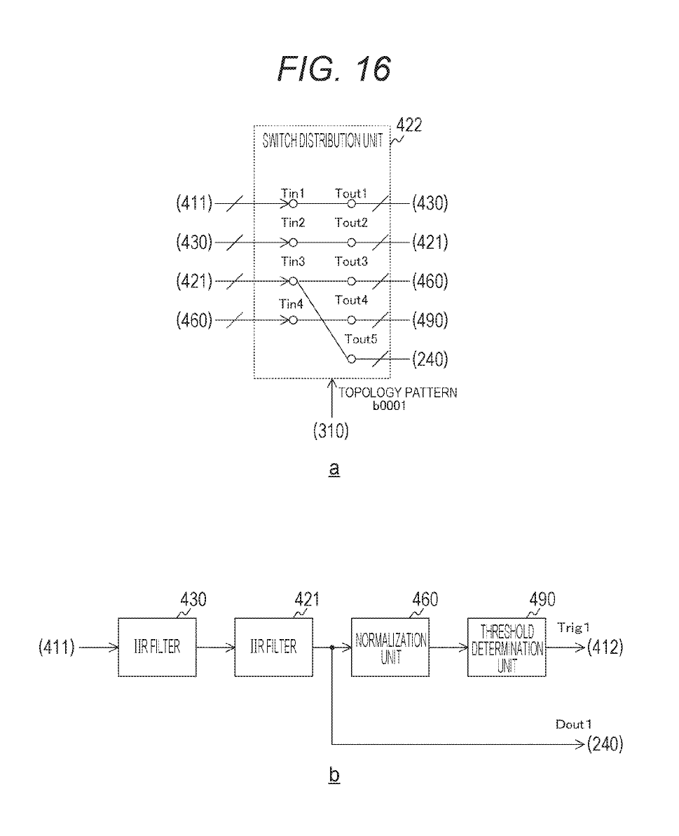

FIG. 16 is a diagram showing an example setting of a topology pattern b0001 according to the first embodiment. In the drawing, “a” shows an example setting of a switch distribution unit 422 in this topology pattern. The input terminal Tin1 is connected to the output terminal Tout1, and the input terminal Tin2 is connected to the output terminal Tout2. Also, the input terminal Tin3 is connected to the output terminals Tout3 and Tout5, and the input terminal Tin4 is connected to the output terminal Tout4.

In FIG. 16, “b” shows an example of the connection relation among the components in a function execution circuit 420 in a case where the topology pattern b0001 is set. In this topology pattern, data that has passed through the IIR filter 430, the IIR filter 421, and the normalization unit 460 in this order is input to the threshold determination unit 490. Also, data that has passed through the IIR filter 430 and the IIR filter 421 is output as the sensor data Dout1.

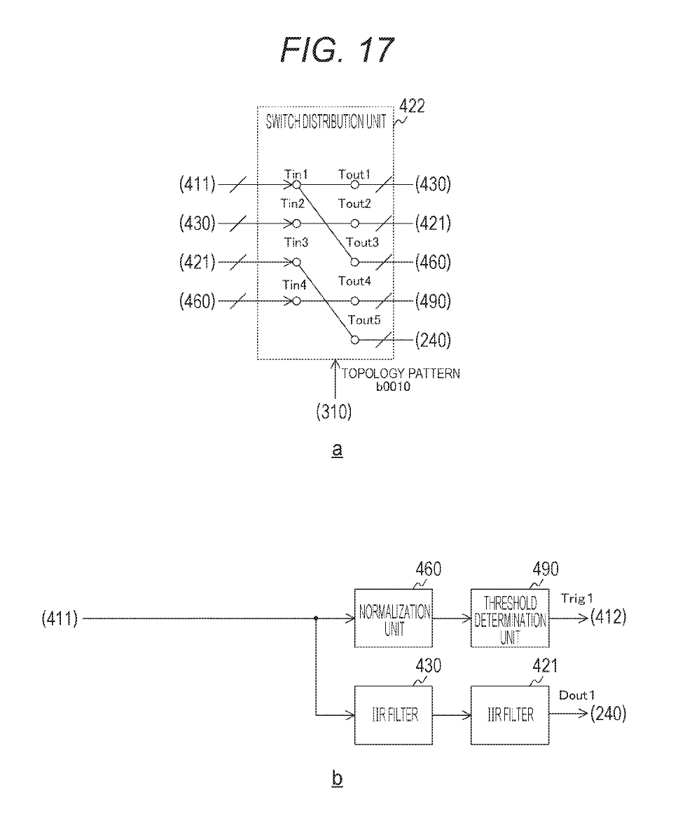

FIG. 17 is a diagram showing an example setting of a topology pattern b0010 according to the first embodiment. In the drawing, “a” shows an example setting of a switch distribution unit 422 in this topology pattern. The input terminal Tin1 is connected to the output terminals Tout1 and Tout3, and the input terminal Tin2 is connected to the output terminal Tout2. Also, the input terminal Tin3 is connected to the output terminal Tout5, and the input terminal Tin4 is connected to the output terminal Tout4.

In FIG. 17, “b” shows an example of the connection relation among the components in a function execution circuit 420 in a case where the topology pattern b0010 is set. In this topology pattern, data that has passed through only the normalization unit 460 is input to the threshold determination unit 490. Also, data that has passed through the IIR filter 430 and the IIR filter 421 is output as the sensor data Dout1.

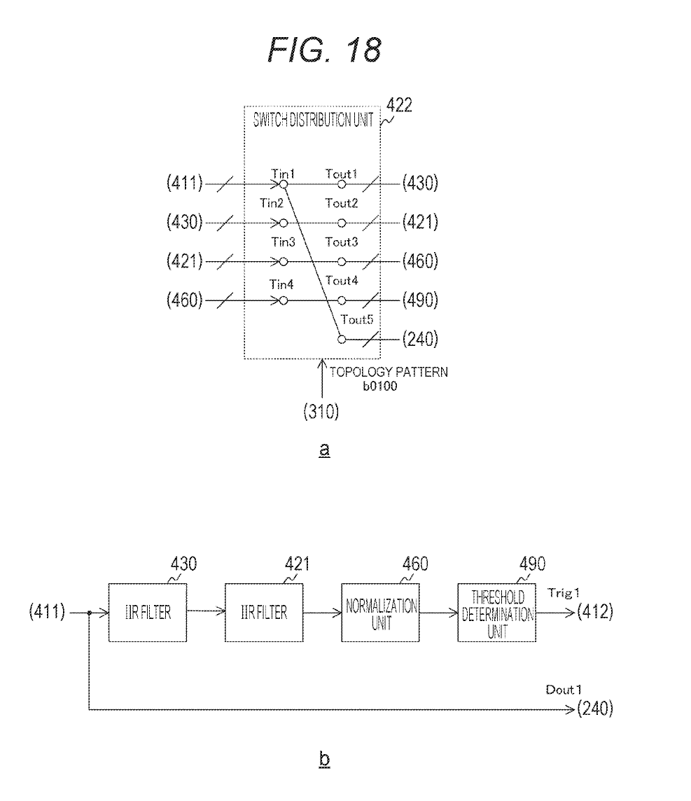

FIG. 18 is a diagram showing an example setting of a topology pattern b0100 according to the first embodiment. In the drawing, “a” shows an example setting of a switch distribution unit 422 in this topology pattern. The input terminal Tin1 is connected to the output terminals Tout1 and Tout5, and the input terminal Tin2 is connected to the output terminal Tout2. Also, the input terminal Tin3 is connected to the output terminal Tout3, and the input terminal Tin4 is connected to the output terminal Tout4.

In FIG. 18, “b” shows an example of the connection relation among the components in a function execution circuit 420 in a case where the topology pattern b0100 is set. In this topology pattern, data that has passed through the IIR filter 430, the IIR filter 421, and the normalization unit 460 in this order is input to the threshold determination unit 490. Further, data from the function assignment unit 411 is output as the sensor data Dout1 without any change.

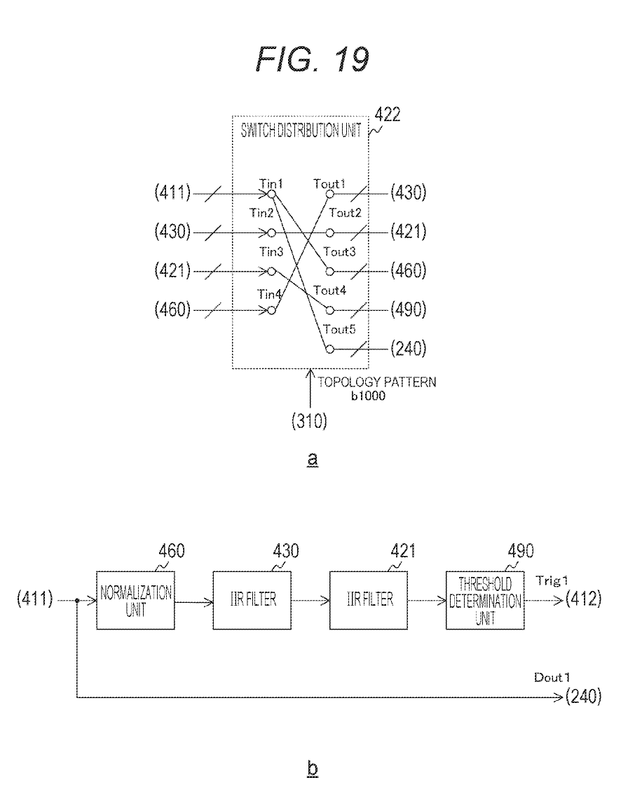

FIG. 19 is a diagram showing an example setting of a topology pattern b1000 according to the first embodiment. In the drawing, “a” shows an example setting of a switch distribution unit 422 in this topology pattern. The input terminal Tin1 is connected to the output terminals Tout3 and Tout5, and the input terminal Tin2 is connected to the output terminal Tout2. Also, the input terminal Tin3 is connected to the output terminal Tout4, and the input terminal Tin4 is connected to the output terminal Tout1.

In FIG. 19, “b” shows an example of the connection relation among the components in a function execution circuit 420 in a case where the topology pattern b1000 is set. In this topology pattern, data that has passed through the normalization unit 460, the IIR filter 430, and the IIR filter 421 in this order is input to the threshold determination unit 490. Further, data from the function assignment unit 411 is output as the sensor data Dout1 without any change.

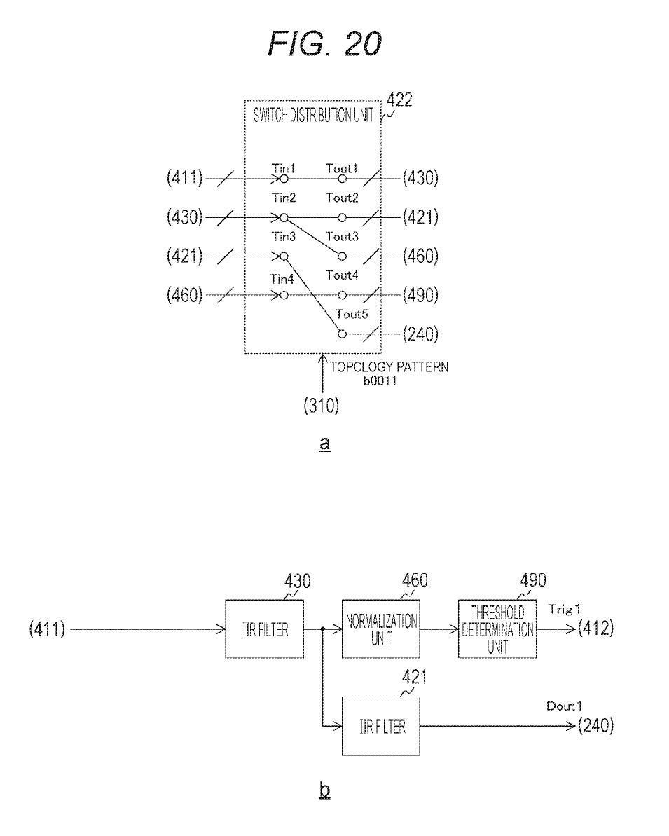

FIG. 20 is a diagram showing an example setting of a topology pattern b0011 according to the first embodiment. In the drawing, “a” shows an example setting of a switch distribution unit 422 in this topology pattern. The input terminal Tin1 is connected to the output terminal Tout1, and the input terminal Tin2 is connected to the output terminals Tout2 and Tout3. Also, the input terminal Tin3 is connected to the output terminal Tout5, and the input terminal Tin4 is connected to the output terminal Tout4.

In FIG. 20, “b” shows an example of the connection relation among the components in a function execution circuit 420 in a case where the topology pattern b0011 is set. In this topology pattern, data that has passed through the IIR filter 430 and the normalization unit 460 in order is input to the threshold determination unit 490. Also, data that has passed through the IIR filter 430 and the IIR filter 421 is output as the sensor data Dout1.

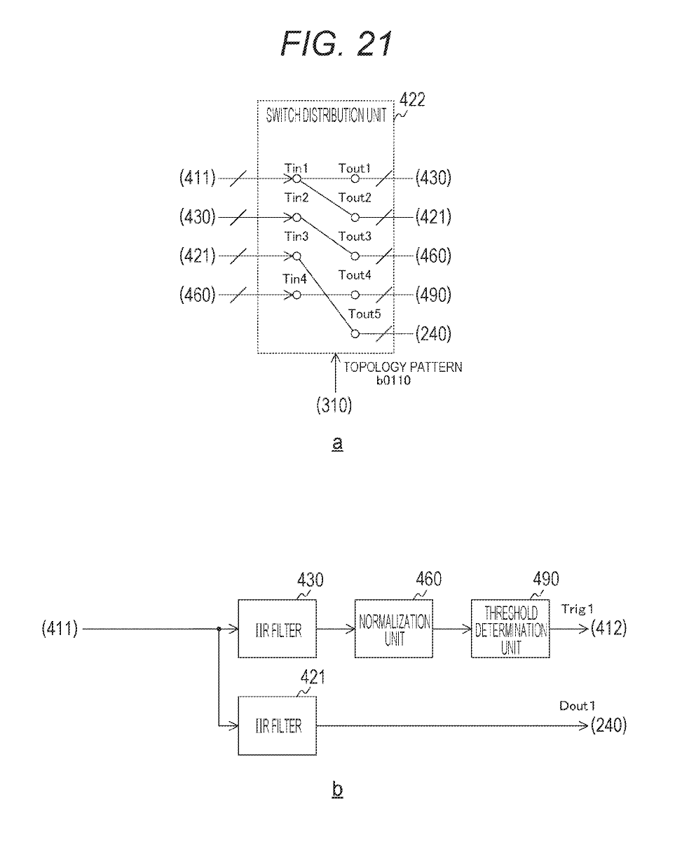

FIG. 21 is a diagram showing an example setting of a topology pattern b0110 according to the first embodiment. In the drawing, “a” shows an example setting of a switch distribution unit 422 in this topology pattern. The input terminal Tin1 is connected to the output terminals Tout1 and Tout2, and the input terminal Tin2 is connected to the output terminal Tout3. Also, the input terminal Tin3 is connected to the output terminal Tout5, and the input terminal Tin4 is connected to the output terminal Tout4.

In FIG. 21, “b” shows an example of the connection relation among the components in a function execution circuit 420 in a case where the topology pattern b0110 is set. In this topology pattern, data that has passed through the IIR filter 430 and the normalization unit 460 in order is input to the threshold determination unit 490. Further, data that has passed through only the IIR filter 421 is output as the sensor data Dout1.

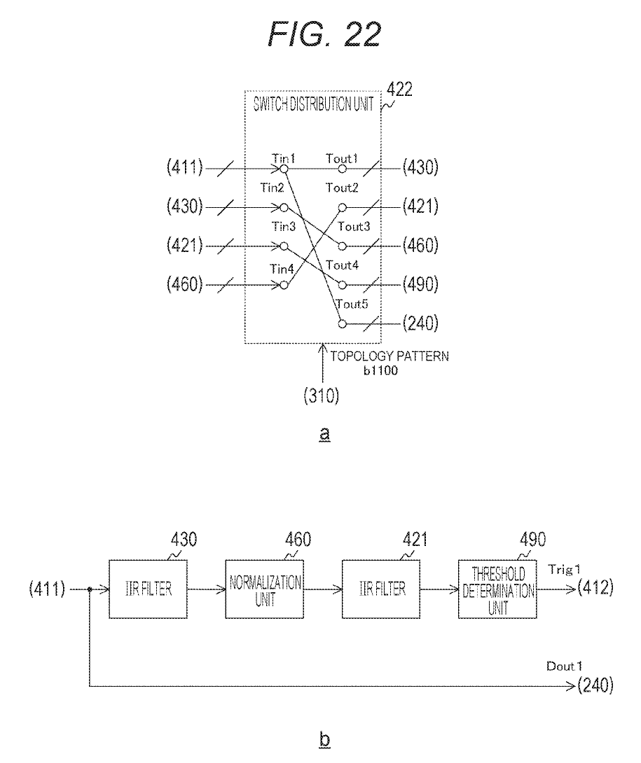

FIG. 22 is a diagram showing an example setting of a topology pattern b100 according to the first embodiment. In the drawing, “a” shows an example setting of a switch distribution unit 422 in this topology pattern. The input terminal Tin1 is connected to the output terminals Tout1 and Tout5, and the input terminal Tin2 is connected to the output terminal Tout3. Also, the input terminal Tin3 is connected to the output terminal Tout4, and the input terminal Tin4 is connected to the output terminal Tout2.

In FIG. 22, “b” shows an example of the connection relation among the components in a function execution circuit 420 in a case where the topology pattern b1100 is set. In this topology pattern, data that has passed through the IIR filter 430, the normalization unit 460, and the IIR filter 421 in this order is input to the threshold determination unit 490. Further, data from the function assignment unit 411 is output as the sensor data Dout1 without any change.

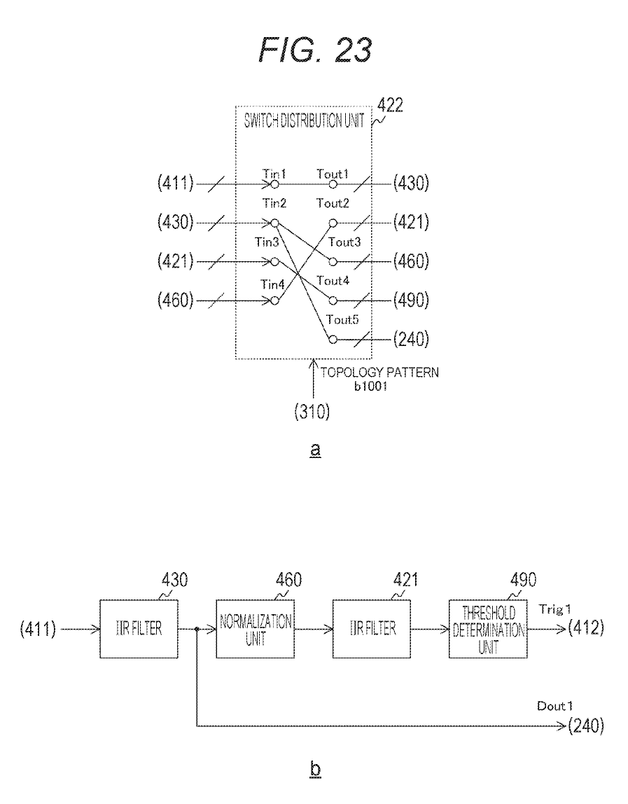

FIG. 23 is a diagram showing an example setting of a topology pattern b1001 according to the first embodiment. In the drawing, “a” shows an example setting of a switch distribution unit 422 in this topology pattern. The input terminal Tin1 is connected to the output terminal Tout1, and the input terminal Tin2 is connected to the output terminals Tout3 and Tout5. Also, the input terminal Tin3 is connected to the output terminal Tout4, and the input terminal Tin4 is connected to the output terminal Tout2.

In FIG. 23, “b” shows an example of the connection relation among the components in a function execution circuit 420 in a case where the topology pattern b1001 is set. In this topology pattern, data that has passed through the IIR filter 430, the normalization unit 460, and the IIR filter 421 in this order is input to the threshold determination unit 490. Further, data that has passed through only the IIR filter 430 is output as the sensor data Dout1.

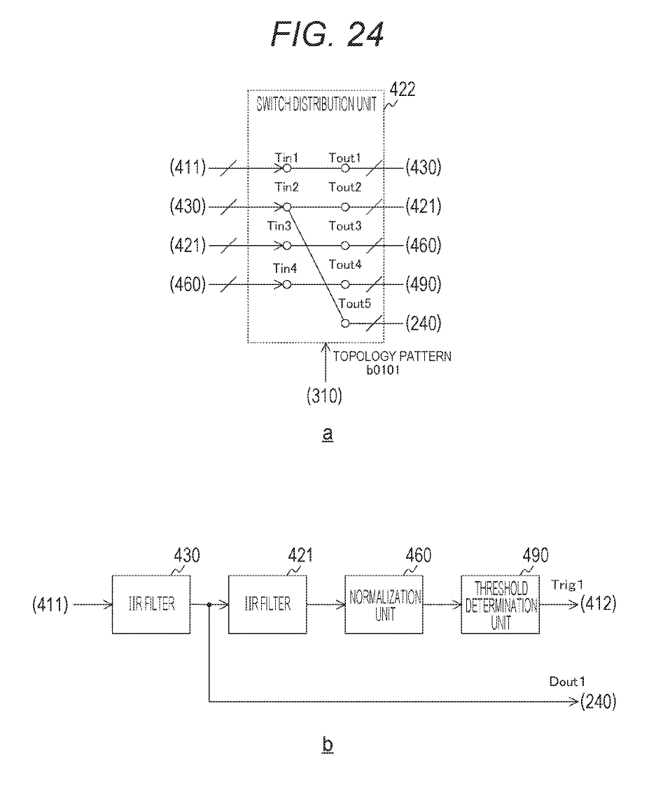

FIG. 24 is a diagram showing an example setting of a topology pattern b0101 according to the first embodiment. In the drawing, “a” shows an example setting of a switch distribution unit 422 in this topology pattern. The input terminal Tin1 is connected to the output terminal Tout1, and the input terminal Tin2 is connected to the output terminals Tout2 and Tout5. Also, the input terminal Tin3 is connected to the output terminal Tout3, and the input terminal Tin4 is connected to the output terminal Tout4.

In FIG. 24, “b” shows an example of the connection relation among the components in a function execution circuit 420 in a case where the topology pattern b0101 is set. In this topology pattern, data that has passed through the IIR filter 430, the IIR filter 421, and the normalization unit 460 in this order is input to the threshold determination unit 490. Further, data that has passed through only the IIR filter 430 is output as the sensor data Dout1.

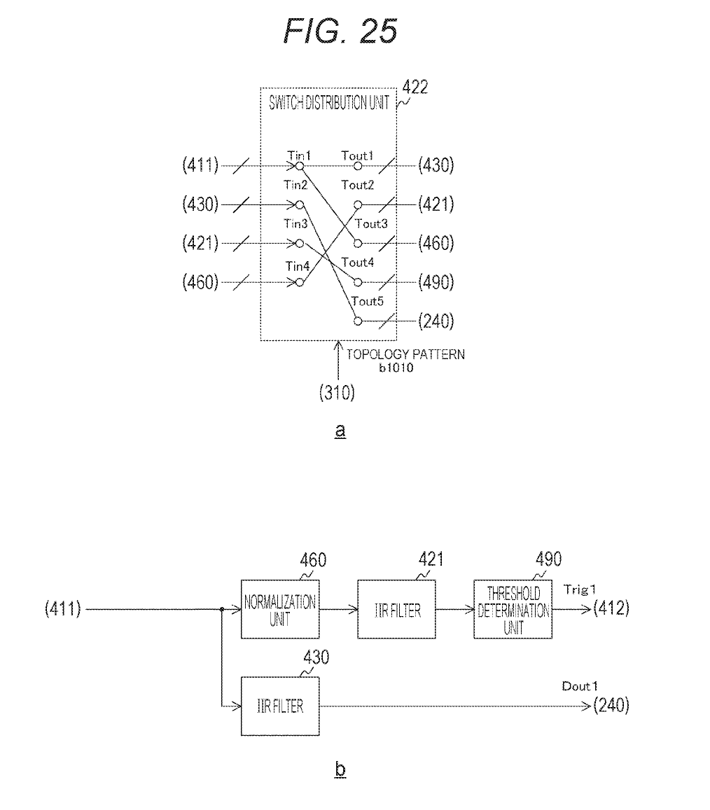

FIG. 25 is a diagram showing an example setting of a topology pattern b1010 according to the first embodiment. In the drawing, “a” shows an example setting of a switch distribution unit 422 in this topology pattern. The input terminal Tin1 is connected to the output terminals Tout1 and Tout3, and the input terminal Tin2 is connected to the output terminal Tout5. Also, the input terminal Tin3 is connected to the output terminal Tout4, and the input terminal Tin4 is connected to the output terminal Tout2.

In FIG. 25, “b” shows an example of the connection relation among the components in a function execution circuit 420 in a case where the topology pattern b1010 is set. In this topology pattern, data that has passed through the normalization unit 460 and the IIR filter 421 in this order is input to the threshold determination unit 490. Further, data that has passed through only the IIR filter 430 is output as the sensor data Dout1.

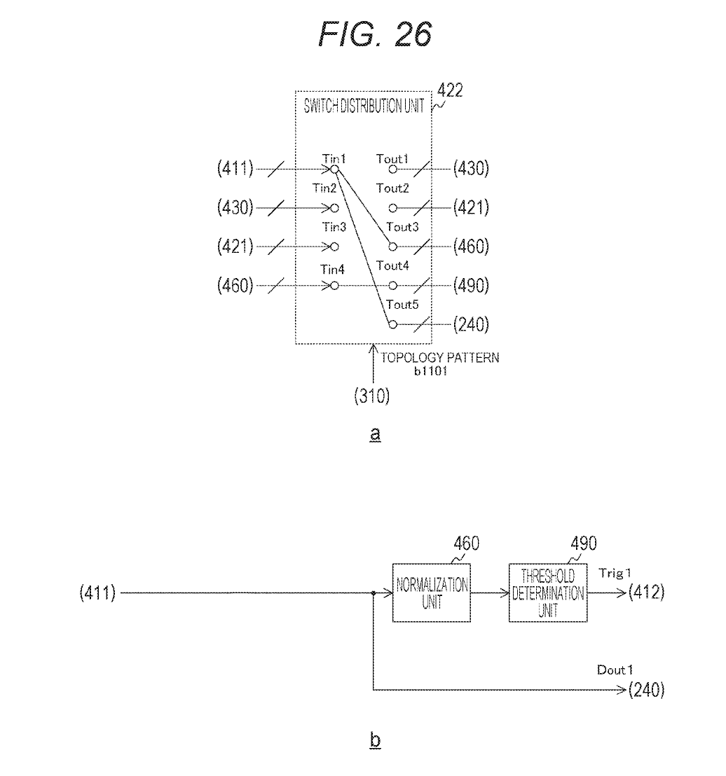

FIG. 26 is a diagram showing an example setting of a topology pattern b1101 according to the first embodiment. In the drawing, “a” shows an example setting of a switch distribution unit 422 in this topology pattern. The input terminal Tin1 is connected to the output terminals Tout3 and Tout5, and the input terminal Tin2 is not connected to any output terminal. Further, the input terminal Tin3 is not connected to any output terminal, and the input terminal Tin4 is connected to the output terminal Tout4.

In FIG. 26, “b” shows an example of the connection relation among the components in a function execution circuit 420 in a case where the topology pattern b1101 is set. In this topology pattern, data that has passed through only the normalization unit 460 is input to the threshold determination unit 490. Further, data from the function assignment unit 411 is output as the sensor data Dout1 without any change.

As shown in FIGS. 16 through 26, a function execution circuit 420 can change the topology of the IIR filter 430, the IIR filter 421, the normalization unit 460, and the threshold determination unit 490 into various shapes, in accordance with register set values. Because of this, it is possible to change the contents of signal processing to be performed on sensor data, simply by changing the register setting values without any change in the circuit design. Thus, versatility of the control circuit 105 can be increased.

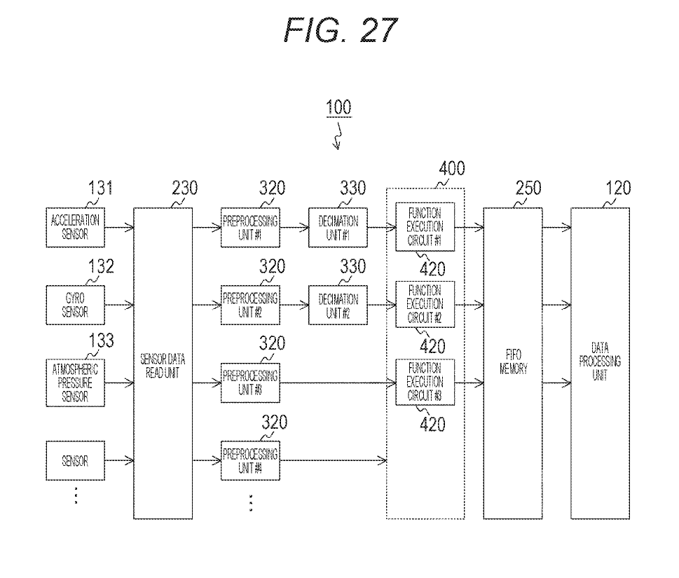

FIG. 27 is a diagram showing an example of data paths according to the first embodiment. As shown in the drawing, the sensor data of the acceleration sensor 131 is read out by the sensor data read unit 230, passes through the preprocessing unit #1, the decimation unit #1, and the function execution unit 400 in this order, and is written into the FIFO memory 250. The same applies to the gyro sensor 132.

On the other hand, the sensor data of the atmospheric pressure sensor 133 read out by the sensor data read unit 230 passes through the preprocessing unit #3 and the function execution unit 400 in this order, and is written into the FIFO memory 250. Each set of the data written in the FIFO memory 250 is read and processed by the data processing unit 120. In this manner, data paths that extend through decimation units 330, and data paths that do not extend through any decimation unit 330 are formed.

[Example Operation of the Electronic Device]

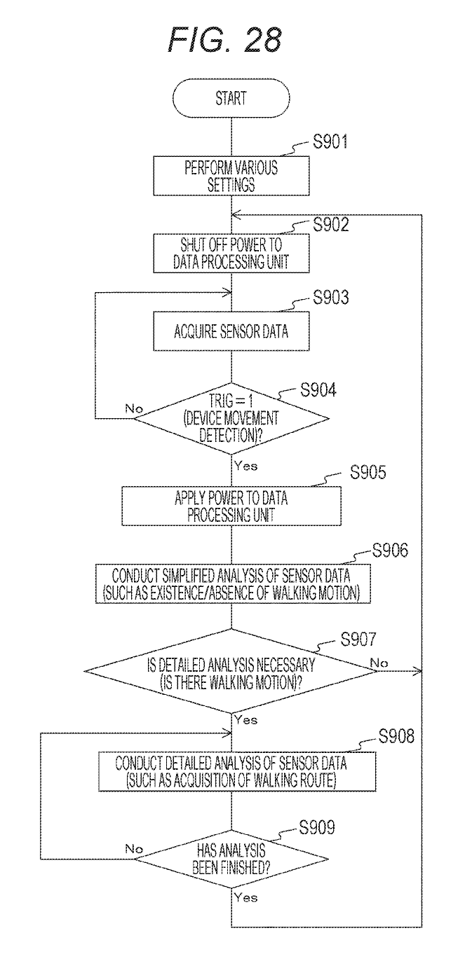

FIG. 28 is a flowchart showing an example operation of the electronic device 100 according to the first embodiment. This operation starts when a predetermined application is executed in the electronic device 100, for example.

The data processing unit 120 performs various settings in the sensor data acquisition unit 200, using register set values (step S901). For example, the data processing unit 120 sets the sampling period, the sampling start time, the details of data format conversion, the conditions (such as the upper limit value, the lower limit value, and the set number of times) for generating the trigger signal TRIG, and the details of calculations (such as coefficients and gain) in the function execution unit 400.

The data processing unit 120 outputs a power-off request, and the power control unit 110 stops the power supply to the data processing unit 120 (step S902). The sensor data acquisition unit 200 then acquires sensor data in accordance with the register set values (step S903).

The power control unit 110 determines whether the trigger signal TRIG is at the high level (or whether the electronic device 100 has moved) (step S904). If the trigger signal TRIG is at the low level (there is no movement) (step S904: No), the electronic device 100 repeats step S903 and the steps that follow.

If the trigger signal TRIG is at the high level (step S904: Yes), on the other hand, the power control unit 110 applies power to the data processing unit 120 (step S905). The data processing unit 120 then reads FIFO data from the FIFO memory 250, and conducts simplified analysis on the presence/absence of walking motion or the like (step S906).

In accordance with the presence/absence of walking motion or the like, the data processing unit 120 determines whether detailed analysis is further required (step S907). If detailed analysis is necessary (step S907: Yes), the data processing unit 120 activates the detailed analysis module 123, and conducts detailed analysis such as acquisition of a walking route (step S908). The data processing unit 120 determines whether the analysis has been finished (step S909).

If the analysis has not been finished (step S909: No), the data processing unit 120 repeats step S908. If the analysis has been finished (step S909: Yes) or detailed analysis is not necessary (step S907: No), on the other hand, the data processing unit 120 repeats step S902.

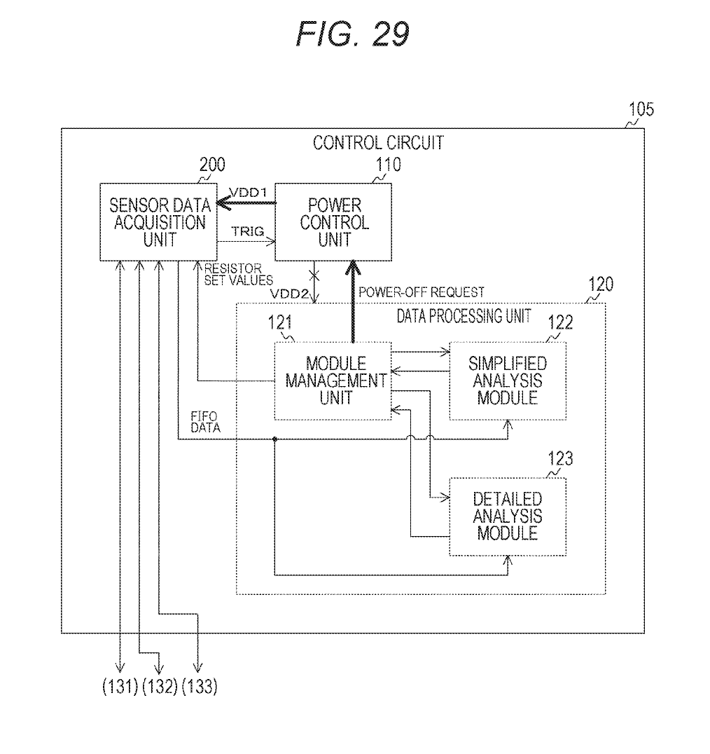

FIG. 29 is a diagram showing an example state of the control circuit 105 prior to movement detection according to the first embodiment. In the control circuit 105, the portions surrounded by dotted lines represent regions to which power is applied, and the portions surrounded by solid lines represent regions to which power is not applied.

When the data processing unit 120 issues a power-off request after the register set values are set, the power control unit 110 stops the power supply to the data processing unit 120. As a result, in the control circuit 105, power is supplied only to the minimum necessary regions such as the power control unit 110 and the sensor data acquisition unit 200.

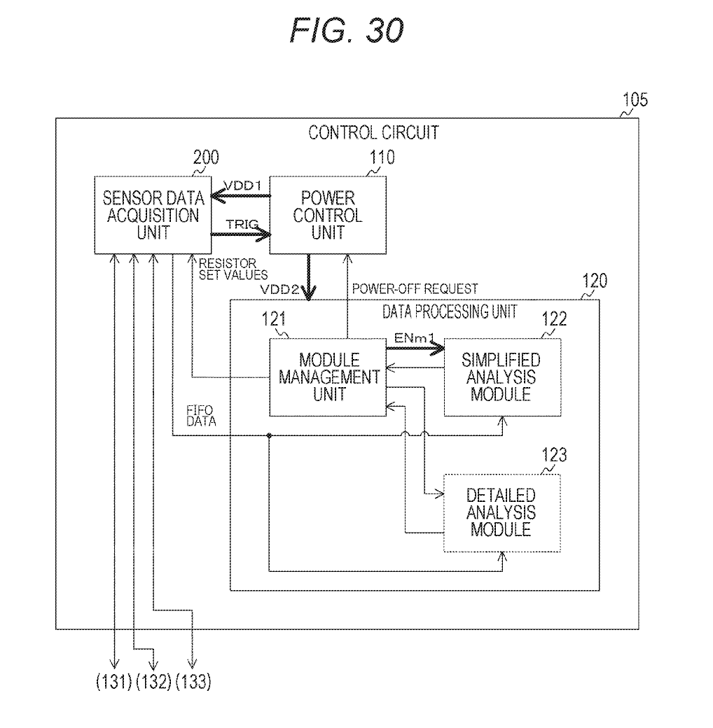

FIG. 30 is a diagram showing an example state of the control circuit 105 at a time of simplified analysis after movement detection according to the first embodiment. The sensor data acquisition unit 200 determines the presence/absence of movement of the electronic device 100, in accordance with acquired sensor data. If there is movement, the sensor data acquisition unit 200 generates the trigger signal TRIG. In accordance with this trigger signal TRIG, the power control unit 110 applies the power VDD2 to the data processing unit 120. The data processing unit 120 then activates the simplified analysis module 122, and conducts simplified analysis. At this stage, the detailed analysis module 123 remains off, to save power. It should be noted that, In the absence of movement, the data processing unit 120 supplies a power-off supply to the power control unit 110, so that the power supply to the data processing unit 120 is shut off.

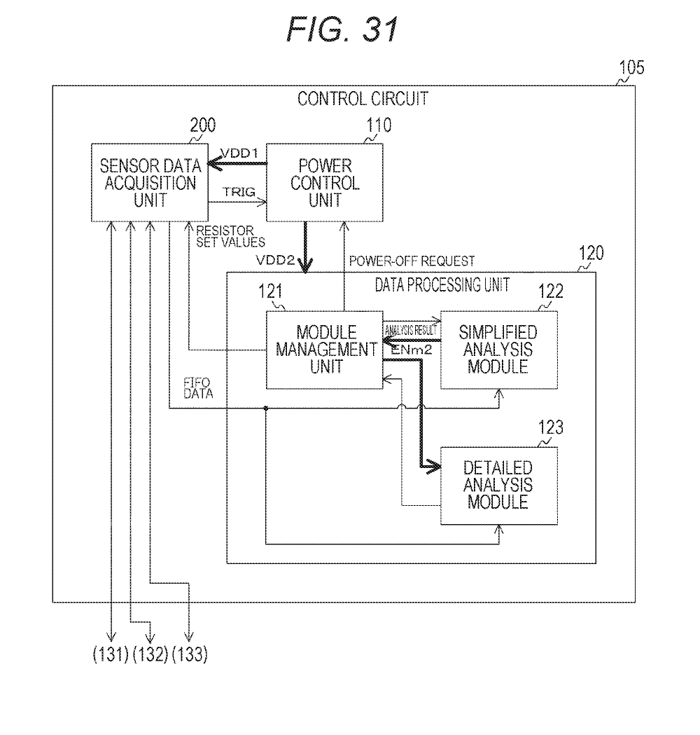

FIG. 31 is a diagram showing an example state of the control circuit 105 at a time of detailed analysis according to the first embodiment. If the simplified analysis module 122 determines that the user is walking, the data processing unit 120 further activates the detailed analysis module 123, and conducts detailed analysis. Note that although the module management unit 121 allows the simplified analysis module 122 to operate while the detailed analysis module 123 is in operation, the module management unit 121 may be designed to turn off the simplified analysis module 122 while the detailed analysis module 123 is in operation.

As shown in FIGS. 29 through 31, the electronic device 100 stops the power supply to the circuits, other than the minimum necessary functional blocks (the power control unit 110 and the sensor data acquisition unit 200) for collecting data from the acceleration sensor 131 and the like. If power is supplied to a circuit that is not in operation, leakage current might be generated, and electric power might be unnecessarily consumed. In the electronic device 100, however, the power supply is also stopped, and thus, generation of leakage current can be minimized. For example, in a state where only the power control unit 110 and the sensor data acquisition unit 200 are made to operate as shown in FIG. 30, power consumption can be reduced to 100 microwatts (μW) or less.

Further, as the sensor data acquisition unit 200 is made to operate with an independent operation clock at a lower frequency than that for the data processing unit 120, power consumption can be made smaller than that in a case where the operation clocks for the data processing unit 120 and the sensor data acquisition unit 200 are the same. For example, the power consumption in the state shown in FIG. 30 can be reduced to 1 microwatt (μW) or less by lowering the operation clock of the sensor data acquisition unit 200.

As described above, according to the first embodiment of the present technology, when there is movement in an electronic device, simplified analysis is carried out to determine whether the user is walking. If the user is walking, detailed analysis is conducted. Thus, only simplified analysis is carried out in a case where the user is not walking though there is movement. Thus, the power consumption by the electronic device 100 can be made smaller than that in a case where detailed analysis is carried out when there is movement, regardless of whether the user is walking.

### 2. Second Embodiment

In the first embodiment described above, a sensor (the acceleration sensor 131 or the like) that performs only measurement is provided. However, it is possible to adopt a sensor that not only performs measurement but also determines whether a measurement value is greater than a threshold value. A sensor that performs advanced processing such as threshold determination in addition to measurement is also called a smart sensor. An electronic device 100 according to a second embodiment differs from the first embodiment in including a smart sensor.

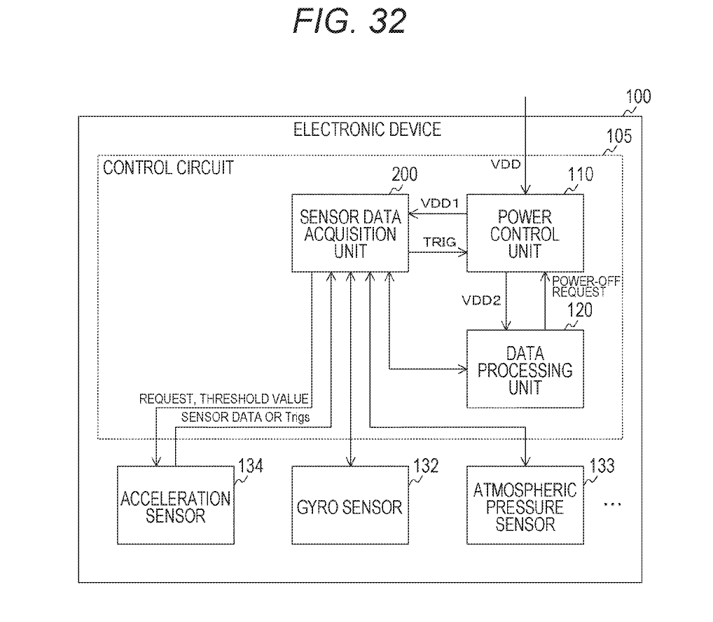

FIG. 32 is a block diagram showing an example configuration of the electronic device 100 according to the second embodiment. The electronic device 100 according to the second embodiment differs from the first embodiment in including an acceleration sensor 134 in place of the acceleration sensor 131.

The acceleration sensor 134 measures an acceleration rate, and determines whether the measurement value is greater than a threshold value. The threshold value in the threshold determination is set beforehand by the sensor data acquisition unit 200 or the like. In response to a request, the acceleration sensor 134 outputs sensor data to the sensor data acquisition unit 200. The acceleration sensor 134 also determines whether the measurement value of the acceleration rate is greater than the threshold value, and supplies a trigger signal Trigs indicating the determination result to the sensor data acquisition unit 200.

Further, the data processing unit 120 of the second embodiment can be designed to execute transactions after an interrupt (the trigger signal Trigs) from the acceleration sensor 134. In this case, when the trigger signal Trigs is output, the sensor data acquisition unit 200 executes a certain number of transactions.

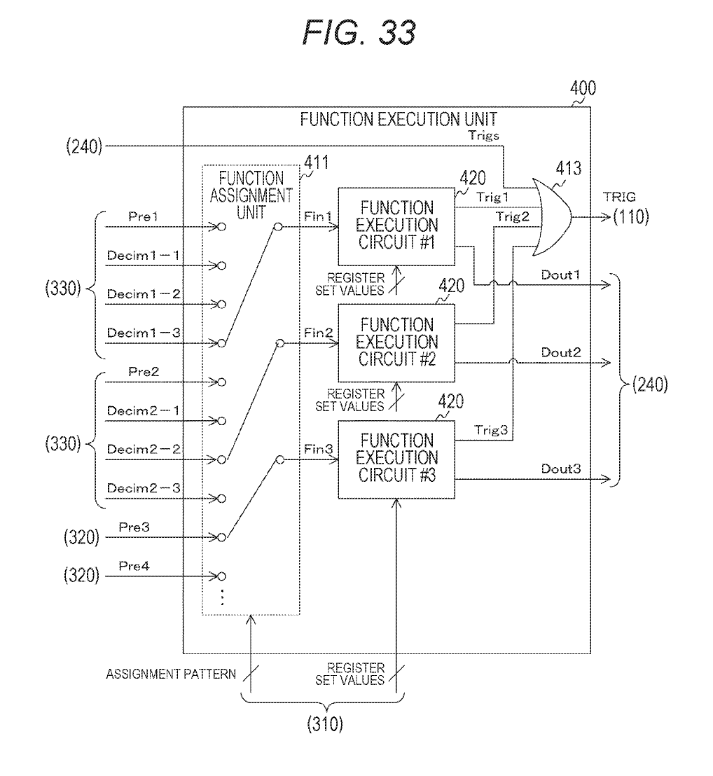

FIG. 33 is a block diagram showing an example configuration of a function execution unit 400 according to the second embodiment. The function execution unit 400 according to the second embodiment differs from the first embodiment in including an OR gate 413 in place of the OR gate 412.

The OR gate 413 generates a trigger signal TRIG that is the logical sum of the trigger signal Trigs from the acceleration sensor 134 and trigger signals Trig1 through Trig3 from the function execution circuits 420.

As described above, according to the second embodiment of the present technology, the power control unit 110 applies power to the data processing unit 120 in accordance with a trigger signal from the acceleration sensor 134. Because of this, the sensor data acquisition unit 200 does not need to compare the data of the acceleration sensor 134 with a threshold value. Thus, the load on the sensor data acquisition unit 200 can be reduced.

### 3. Third Embodiment

In the first embodiment described above, the FIFO memory 250 is provided in the sensor data acquisition unit 200. However, as the size of the FIFO memory 250 increases, the power consumption by the FIFO memory 250 also increases. An electronic device 100 according to a third embodiment differs from the first embodiment in that the power consumption by the FIFO memory 250 is reduced.

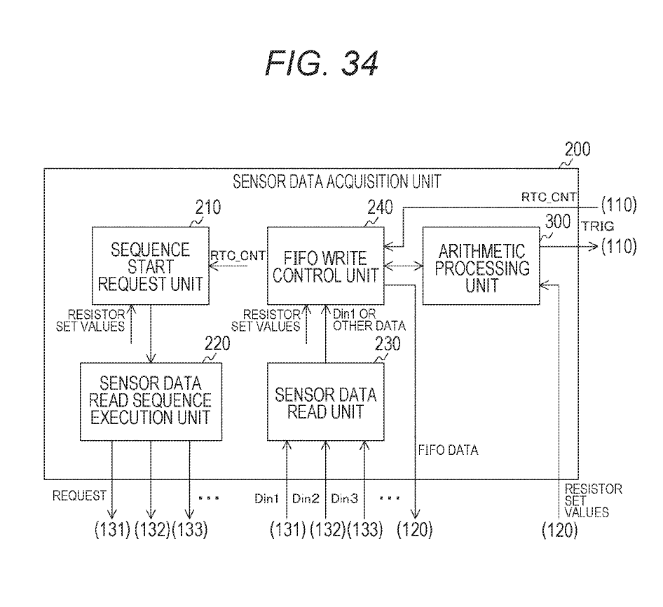

FIG. 34 is a block diagram showing an example configuration of a sensor data acquisition unit 200 according to the third embodiment. The configuration of the sensor data acquisition unit 200 of the third embodiment is similar to that of the first embodiment, except for not including the FIFO memory 250.

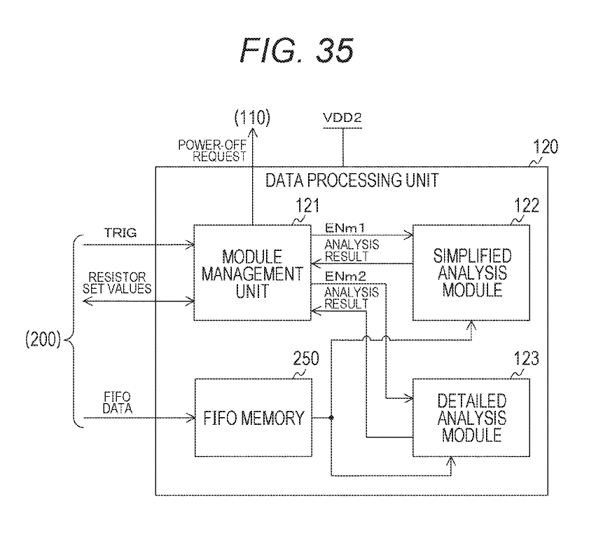

FIG. 35 is a block diagram showing an example configuration of a data processing unit 120 according to the third embodiment. The data processing unit 120 according to the third embodiment differs from the first embodiment in further including the FIFO memory 250.

As described above, the data processing unit 120 is not made to start operation, unless movement of the electronic device 100 is detected. On the other hand, the sensor data acquisition unit 200 is always in operation while power is being applied to the electronic device 100. Because of this, the FIFO memory 250 is provided in the data processing unit 120, not in the sensor data acquisition unit 200. Thus, power consumption by the FIFO memory 250 can be reduced.

As described above, according to the third embodiment of the present technology, the FIFO memory 250 is disposed in the data processing unit 120 to which power is applied when there is movement in the electronic device 100. Accordingly, when there is no movement, the power supply to the FIFO memory 250 can be shut off. Thus, power consumption by the electronic device 100 can be further reduced.

[Modification]

In the above described first embodiment, the electronic device 100 is equipped with the acceleration sensor 131 and the like. However, a pulse wave sensor may be further included. An electronic device 100 according to this modification differs from the first embodiment in further including a pulse wave sensor.

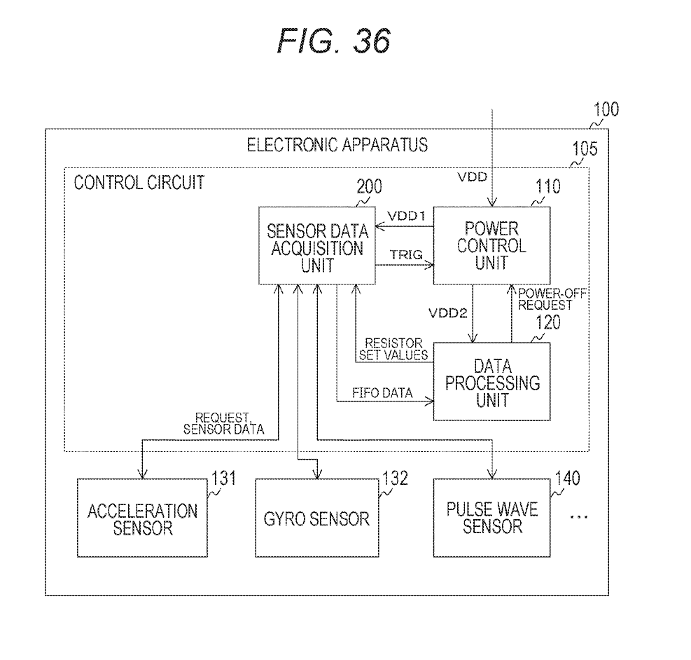

FIG. 36 is a block diagram showing an example configuration of the electronic device 100 according to the modification. The electronic device 100 according to this modification differs from the first embodiment in including a pulse wave sensor 140. The pulse wave sensor 140 measures fluctuation (pulse wave) of the volume of a blood vessel.

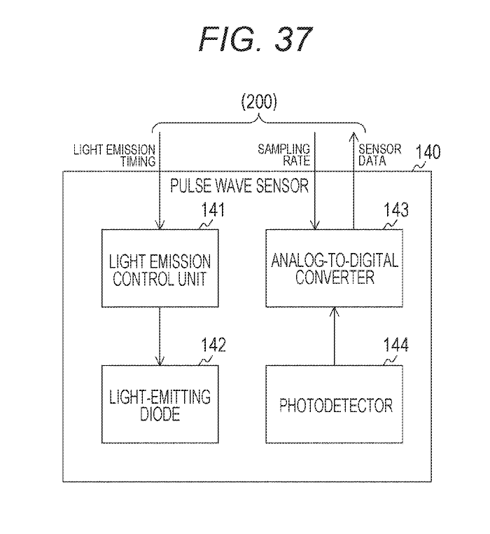

FIG. 37 is a block diagram showing an example configuration of the pulse wave sensor 140 according to the modification. The pulse wave sensor 140 includes a light emission control unit 141, a light-emitting diode 142, an analog-to-digital converter 143, and a photodetector 144.

The light emission control unit 141 causes the light-emitting diode 142 to emit light, under the control of the sensor data acquisition unit 200. The light-emitting diode 142 emits light of a predetermined wavelength (red or green), under the control of the light emission control unit 141.

The photodetector 144 detects light reflected by a blood vessel, and generates an analog sensor signal. The analog-to-digital converter 143 converts the analog signal from the photodetector 144 into digital sensor data at a sampling rate set by the sensor data acquisition unit 200.

The sensor data acquisition unit 200 causes the light-emitting diode 142 to emit light intermittently, and controls the light emission intensity and light emission timing thereof, and the sampling rate of the analog-to-digital converter 143. In doing so, the sensor data acquisition unit 200 synchronizes the light emission timing of the light-emitting diode 142 with the sampling timing of the analog-to-digital converter 143. For example, the ratio between the emission period of the light-emitting diode 142 and the sampling period is set at an integer ratio. As the light-emitting diode 142 is made to emit light intermittently in this manner, power consumption of the pulse wave sensor 140 can be reduced to a smaller amount than in a configuration in which the light-emitting diode 142 is made to emit light constantly.

As described above, according to the modification of the present technology, the sensor data acquisition unit 200 causes the light-emitting diode 142 to emit light intermittently, so that power consumption by the pulse wave sensor 140 can be reduced to a smaller amount than in a configuration in which the light-emitting diode 142 is made to emit light constantly.

It should be noted that the above described embodiments are examples for embodying the present technology, and the matter of the embodiments corresponds to the subject matter of the claims. Similarly, the subject matter of the claims corresponds to the matter under the same names as the subject matter of the claims in the embodiments of the present technology. However, the present technology is not limited to the embodiments, and various changes can be made to the embodiments without departing from the scope of the technology.

Also, the processing procedures described above in the embodiments may be regarded as a method involving the series of these procedures, or may be regarded as a program for causing a computer to carry out the series of these procedures or as a recording medium storing the program. This recording medium may be a compact disc (CD), a minidisc (MD), a digital versatile disc (DVD), a memory card, or a Blu-ray (registered trademark) disc, for example.

It should be noted that the effects of the present technology are not necessarily limited to the effects described herein, and may include any of the effects described in the present disclosure.

It should be noted that the present technology may also be embodied in the configurations described below.

(1) An electronic device including:

a detection unit that detects the presence/absence of movement in the electronic device;

a power control unit that starts a supply of electric power in a case where there is movement in the electronic device;

a simplified analysis unit that performs a simplified analysis process while consuming the electric power, the simplified analysis process being a process of analyzing data obtained from the electronic device; and

a detailed analysis unit that performs a detailed analysis process in accordance with an analysis result of the simplified analysis process while consuming the electric power, the detailed analysis process being a different process from the simplified analysis process.

(2) The electronic device according to claim 1, in which,

in the simplified analysis process, the simplified analysis unit analyzes the data and determines whether a user of the electronic device is walking, and

if the user is determined to be walking, the detailed analysis unit performs the detailed analysis process.

(3) The electronic device according to (1), in which the detection unit includes:

a sensor that generates the data; and

a sensor data acquisition unit that acquires the data, and detects the presence/absence of movement in the electronic device in accordance with the data.

(4) The electronic device according to (3), in which the sensor data acquisition unit performs a decimation process of discarding the corresponding number of sets of the data at a predetermined decimation rate every time acquiring a predetermined number of sets of the data, and a detection process of detecting the presence/absence of movement of the electronic device in accordance with the data that has not been discarded.

(5) The electronic device according to (3) or (4), in which the sensor data acquisition unit includes:

a sensor data read unit that reads the data from the sensor;

a filtering unit that performs a predetermined filtering process on the data;

a normalization unit that performs a predetermined normalization process on the data;

a threshold determination unit that compares the data with a predetermined threshold value, and determines the presence/absence of movement of the electronic device; and

a connection control unit that controls a connection relation among the sensor data read unit, the filtering unit, the normalization unit, and the threshold determination unit.

(6) The electronic device according to any of (3) to (5), in which the sensor includes:

a light-emitting diode;

a photodetector that detects the presence/absence of light, and generates an analog detection signal; and

an analog-to-digital converter that converts the detection signal into the data, and

the sensor data acquisition unit synchronizes light emission timing of the light-emitting diode with timing at which the analog-to-digital converter converts the detection signal.

(7) The electronic device according to any of (3) to (6), in which

the sensor data acquisition unit includes

a holding unit that holds a constant number of sets of the data in order of acquisition of the data, and

the simplified analysis unit performs the simplified analysis process by reading the data from the holding unit in the order of acquisition of the data.

(8) The electronic device according to (7), in which the holding unit holds the data and the time at which the data was acquired, the data and the time being associated with each other.

(9) The electronic device according to any of (1) to (8), further including

a holding unit that holds a constant number of sets of the data in order of acquisition of the data, using the electric power, and

the simplified analysis unit performs the simplified analysis process by reading the data from the holding unit in the order of acquisition of the data.

(10) The electronic device according to (1), in which the detection unit includes:

a sensor that generates the data, and senses the presence/absence of movement of the electronic device in accordance with the data; and

a data acquisition unit that acquires the data.

(11) A control circuit including:

a power control unit that starts a supply of electric power in a case where there is movement in an electronic device;

a simplified analysis unit that performs a simplified analysis process while consuming the electric power, the simplified analysis process being a process of analyzing data obtained from the electronic device; and

a detailed analysis unit that performs a detailed analysis process in accordance with an analysis result of the simplified analysis process while consuming the electric power, the detailed analysis process being a different process from the simplified analysis process.

(12) A method of controlling an electronic device,

the method including:

a detection step of detecting the presence/absence of movement in the electronic device;

a power control step of starting a supply of electric power in a case where there is movement in the electronic device;

a simplified analysis step of performing a simplified analysis process while consuming the electric power, the simplified analysis process being a process of analyzing data obtained from the electronic device; and

a detailed analysis step of performing a detailed analysis process in accordance with an analysis result of the simplified analysis process while consuming the electric power, the detailed analysis process being a different process from the simplified analysis process.

### REFERENCE SIGNS LIST

100 Electronic device
105 Control circuit
110 Power control unit
111 Real-time clock
112 Power management unit
120 Data processing unit
121 Module management unit
122 Simplified analysis module
123 Detailed analysis module
131, 134 Acceleration sensor
132 Gyro sensor
133 Atmospheric pressure sensor
140 Pulse wave sensor
141 Light emission control unit
142 Light-emitting diode
143 Analog-to-digital converter
144 Photodetector
200 Sensor data acquisition unit
210 Sequence start request unit
220 Sensor read sequence execution unit
230 Sensor data read unit
240 FIFO write control unit
250 FIFO memory
251, 252 Data area
300 Arithmetic processing unit
310 Control register
320 Preprocessing unit
321 Signed binary number conversion unit
322, 341, 344, 354, 357, 432, 437, 439, 444, 475, 482 Adder
323, 435, 441, 442, 447, 448, 468, 469, 470, 471, 472 Multiplier
324, 450, 477, 478 Rounding/clipping processing unit
330 Decimation unit
331, 332, 333, 334 Dynamic range adjustment unit
340 Common processing unit
342, 345, 355, 358 Wraparound processing unit
343, 346, 352, 353, 356 Register
350 Decimator
351, 361 Switch
359 Left bit shift processing unit
360 Saturating rounding operation unit
362, 451, 452, 473, 474, 483 Selector
363 Input/output control unit
400 Function execution unit
411 Function assignment unit
412, 413, 497 OR (logical add) gate
420 Function execution circuit
421, 430 IIR filter
422 Switch distribution unit
431 Bit shift processing unit
433 Clipping processing unit
436, 440, 443, 446, 449 Rounding processing unit
438, 445 Delay unit
460 Normalization unit
461, 462, 463 Absolute value calculation unit
464, 466 Largest value selection unit
465, 467 Smallest value selection unit
476, 479, 480, 481 Bit format conversion unit
490 Threshold determination unit
491 Upper limit value comparison unit
492 Lower limit value comparison unit
493 Upper-limit-side counter
494 Lower-limit-side counter
495 Upper-limit-side counter value comparison unit
496 Lower-limit-side counter value comparison unit
498 Delay unit

1. An electronic device comprising:
a detection unit that detects presence/absence of movement in the electronic device;
a power control unit that starts a supply of electric power in a case where there is movement in the electronic device;
a simplified analysis unit that performs a simplified analysis process while consuming the electric power, the simplified analysis process being a process of analyzing data obtained from the electronic device; and
a detailed analysis unit that performs a detailed analysis process in accordance with an analysis result of the simplified analysis process while consuming the electric power, the detailed analysis process being a different process from the simplified analysis process.

2. The electronic device according to claim 1, wherein,
in the simplified analysis process, the simplified analysis unit analyzes the data, and determines whether a user of the electronic device is walking, and
if the user is determined to be walking, the detailed analysis unit performs the detailed analysis process.

3. The electronic device according to claim 1, wherein the detection unit includes:
a sensor that generates the data; and
a sensor data acquisition unit that acquires the data, and detects presence/absence of movement of the electronic device in accordance with the data.

4. The electronic device according to claim 3, wherein the sensor data acquisition unit performs a decimation process of discarding a corresponding number of sets of the data at a predetermined decimation rate every time acquiring a predetermined number of sets of the data, and a detection process of detecting presence/absence of movement of the electronic device in accordance with the data that has not been discarded.

5. The electronic device according to claim 3, wherein the sensor data acquisition unit includes:
a sensor data read unit that reads the data from the sensor;
a filtering unit that performs a predetermined filtering process on the data;
a normalization unit that performs a predetermined normalization process on the data;
a threshold determination unit that compares the data with a predetermined threshold value, and determines presence/absence of movement of the electronic device; and
a connection control unit that controls a connection relation among the sensor data read unit, the filtering unit, the normalization unit, and the threshold determination unit.

6. The electronic device according to claim 3, wherein the sensor includes:
a light-emitting diode;
a photodetector that detects presence/absence of light, and generates an analog detection signal; and
an analog-to-digital converter that converts the detection signal into the data, and
the sensor data acquisition unit synchronizes light emission timing of the light-emitting diode with timing at which the analog-to-digital converter converts the detection signal.

7. The electronic device according to claim 3, wherein
the sensor data acquisition unit includes
a holding unit that holds a constant number of sets of the data in order of acquisition of the data, and
the simplified analysis unit performs the simplified analysis process by reading the data from the holding unit in the order of acquisition of the data.

8. The electronic device according to claim 7, wherein the holding unit holds the data and a time at which the data was acquired, the data and the time being associated with each other.

9. The electronic device according to claim 1, further comprising
a holding unit that holds a constant number of sets of the data in order of acquisition of the data, using the electric power, and
the simplified analysis unit performs the simplified analysis process by reading the data from the holding unit in the order of acquisition of the data.

10. The electronic device according to claim 1, wherein the detection unit includes:
a sensor that generates the data, and senses presence/absence of movement of the electronic device in accordance with the data; and
a data acquisition unit that acquires the data.

11. A control circuit comprising:
a power control unit that starts a supply of electric power in a case where there is movement in an electronic device;
a simplified analysis unit that performs a simplified analysis process while consuming the electric power, the simplified analysis process being a process of analyzing data obtained from the electronic device; and
a detailed analysis unit that performs a detailed analysis process in accordance with an analysis result of the simplified analysis process while consuming the electric power, the detailed analysis process being a different process from the simplified analysis process.

12. A method of controlling an electronic device,
the method comprising:
a detection step of detecting presence/absence of movement in the electronic device;
a power control step of starting a supply of electric power in a case where there is movement in the electronic device;
a simplified analysis step of performing a simplified analysis process while consuming the electric power, the simplified analysis process being a process of analyzing data obtained from the electronic device; and
a detailed analysis step of performing a detailed analysis process in accordance with an analysis result of the simplified analysis process while consuming the electric power, the detailed analysis process being a different process from the simplified analysis process.
